(19) United States
(12) Patent Application Publication
(10) Pub. No.: US 2026/0239224 A1
(43) Pub. Date: Aug. 13, 2026

(54) DYNAMIC PDSCH POWER ALLOCATION

(71) Applicant: GOOGLE LLC, Mountain View, CA (US)

(72) Inventor: Yushu Zhang, Beijing (CN)

(21) Appl. No.: 19/156,580

(22) PCT Filed: Feb. 22, 2023
(86) PCT No.: PCT/CN2023/077604

§ 371 Date: Aug. 14, 2025

(51) Int. Cl. H04W 52/24; H04L 5/00; H04W 72/542

(52) U.S. Cl. CPC H04W 52/241; H04L 5/0057; H04L 5/0094; H04W 72/542

(57) ABSTRACT

This disclosure enables dynamic transmission power allocation for a physical downlink shared channel (PDSCH) (118). A network entity (104) can transmit a channel state information (CSI) report configuration (106) to a UE (102) that configures the UE (102) to provide a power backoff indicator (PBI) report (116). A CSI report (112) can be modified to include the PBI report (116). The UE may determine the one or more PBIs based on a measured signal-to-interference plus noise ratio (SINR) that is measured for one or more CSI reference signal (CSI-RS) resources. The network entity (104) receives PBI report (116) from the UE (102) and uses one or more PBIs in the PBI report (116) to set the PDSCH transmission power. The network entity (104) can transmit control signaling indicating the transmission power, power offset, or additional power backoff of the PDSCH.

### TECHNICAL FIELD

Aspects of the present disclosure relate generally to wireless communication, and to power allocation for a physical downlink shared channel (PDSCH) based on channel conditions in a wireless communication system.

### BACKGROUND

Wireless communication systems use a physical downlink shared channel (PDSCH) to transmit data from a network entity (such as a base station) to user equipment (UE). Typically, the network entity allocates power for the PDSCH based on channel state information (CSI) that the network entity obtains from the UE in a CSI report. To enable CSI measurement, the network entity configures and transmits a reference signal for the UE to measure. For example, the network entity can configure a CSI report by radio resource control (RRC) signaling (such as the CSI-ReportConfig information element in an RRC message). The RRC signaling configures a channel state information reference signal (CSI-RS) that is used as channel measurement resource (CMR) for the UE to measure the downlink channel. Additionally, the network entity may configure some interference measurement resource (IMR) for UE to measure interference. Based on the configured CMR and IMR, the UE can measure the channel conditions and determine the CSI. The CSI may include at least one of a rank indicator (RI), a precoder matrix indicator (PMI), a channel quality indicator (CQI), or a layer indicator (LI). RI and PMI are used to indicate the digital precoder. CQI is used to indicate the signal-to-interference plus noise ratio (SINR) status so as to assist the network entity to determine the modulation and coding scheme (MCS). LI is used to identify the strongest layer for the reported precoder indicated by RI and PMI. The 3rd Generation Partnership Project (3GPP) standards setting body has defined the CSI measurement procedure and CSI report in technical specification (TS) standards documents. For example, 3GPP TS 38.212 defines the CSI report on PUCCH, 3GPP TS 38.212 defines the CSI report on PUSCH, 3GPP TS 38.214 defines the procedure for CQI measurement and report, and 3GPP TS 38.214 defines the configuration of a CSI-RS resource.

Current procedures for PDSCH power allocation are based on CQI reported by the UE. The UE measures the CMR and IMR to determine a measured signal-to-interference plus noise (SINR). The UE determines the CQI based on the measured SINR and a predefined target spectrum efficiency (SE). The CSI report includes the CQI, which the network entity uses to determine the transmission power (or a transmission power backoff) for the PDSCH. However, there may be instances in which the network entity could support an acceptable quality of service on the PDSCH while using a lower transmission power that would be typically be selected for a particular CQI. Currently, there is no mechanism for a UE to inform the network entity when a CQI could support a lower transmission power and no mechanism for the network entity to configure the lower transmission power.

### BRIEF SUMMARY

The systems, methods, and devices of this disclosure each have several innovative aspects, no single one of which is solely responsible for the desirable attributes disclosed herein.

One innovative aspect of the subject matter described in this disclosure can be implemented as a method of wireless communication at a user equipment (UE). The method includes receiving, via control signaling from a network entity, a channel state information (CSI) report configuration that indicates at least one CSI reference signal (CSI-RS) resource and includes a power backoff indicator (PBI) report configuration, receiving the at least one CSI-RS resource, generating a PBI report that includes one or more power backoff indicators (PBIs) based on measurements of the at least one CSI-RS resource and the PBI report configuration, and transmitting the PBI report in a CSI report from the UE to the network entity.

Another innovative aspect of the subject matter described in this disclosure can be implemented as a method of wireless communication at a network entity (such as a base station). The method includes transmitting, via control signaling to a user equipment (UE), a channel state information (CSI) report configuration that indicates at least one CSI reference signal (CSI-RS) resource and includes a power backoff indicator (PBI) report configuration, transmitting the at least one CSI-RS resource, and receiving a CSI report from the UE, the CSI report including a PBI report that includes one or more power backoff indicators (PBIs).

Another innovative aspect of the subject matter described in this disclosure can be implemented in an apparatus (such as a UE or a network entity). The apparatus includes a communication unit and a processing system. The processing system is configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE SEVERAL VIEWS OF THE DRAWINGS

Note that the relative dimensions of the following figures may not be drawn to scale. Like reference numbers and designations in the various drawings indicate like elements.

FIG. 1 shows an example of a user equipment (UE) and network entity illustrating power allocation for physical downlink shared channel (PDSCH) according to some aspects of this disclosure.

FIG. 2 illustrates an example signal-to-interference plus noise ratio (SINR) measurement and reported channel quality indicator (CQI).

FIG. 3A illustrates an example CQI report distribution chart from a system level simulation.

FIG. 3B illustrates an example for geometry SINR distribution graph from system level simulation.

FIG. 4 illustrates an example message flow and procedure in which a channel state information (CSI) report includes a power backoff indicator (PBI) report.

FIG. 5 illustrates an example message flow and procedure in which a CSI report includes a PBI report based on a CQI subset restriction.

FIG. 6 illustrates an example message flow and procedure in which a CSI report includes a PBI report based on a target spectrum efficiency.

FIG. 7 illustrates an example process for a UE that supports the PBI report according to some aspects of this disclosure.

FIG. 8 illustrates an example process for a network entity that supports the PBI report according to some aspects of this disclosure.

FIG. 9 illustrates an example PBI report in short physical uplink control channel (PUCCH).

FIG. 10A illustrates an example PBI report in CSI part 1 in long PUCCH or physical uplink shared channel (PUSCH).

FIG. 10B illustrates an example PBI report in CSI part 2 in long PUCCH or PUSCH.

FIG. 10C illustrates an example PBI report in CSI part 1 and CSI part 2 in long PUCCH or PUSCH.

FIG. 11 illustrates an example PBI report based on multiple candidate power offsets.

FIG. 12 illustrates an example PBI report based on multiple CSI-RS resources with different power offsets.

FIG. 13 illustrates a first example message flow and procedure for dynamic PDSCH power allocation according to some aspects of this disclosure.

FIG. 14 illustrates a second example message flow and procedure for dynamic PDSCH power allocation according to some aspects of this disclosure.

FIG. 15 illustrates a third example message flow and procedure for dynamic PDSCH power allocation according to some aspects of this disclosure.

FIG. 16 illustrates a fourth example message flow and procedure for dynamic PDSCH power allocation according to some aspects of this disclosure.

FIG. 17 illustrates an example process for a UE that supports dynamic PDSCH transmission power allocation according to some aspects of this disclosure.

FIG. 18 illustrates an example process for a network entity that supports dynamic PDSCH transmission power allocation according to some aspects of this disclosure.

FIG. 19 illustrates an example for the PDSCH power offset or power backoff indication when scheduling offset is below a threshold.

FIG. 20 illustrates an example for the PDSCH power offset or power backoff indication when scheduling offset is above a threshold.

### DETAILED DESCRIPTION

The following description is directed to certain implementations for the purpose of describing the innovative aspects of this disclosure. However, a person having ordinary skill in the art will readily recognize that the teachings herein can be applied in a multitude of different ways. Some of the examples in this disclosure are based on wireless communication according to the 3^{rd} Generation Partnership Project (3GPP) wireless standards, such as the 4th generation (4G) Long Term Evolution (LTE) and 5th generation (5G) New Radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11, 802.15, or 802.16 wireless standards, or other known signals that are used to communicate within a wireless, cellular, or internet of things (IOT) network, such as a system utilizing 3G, 4G, 5G, WiFi or future radio technology.

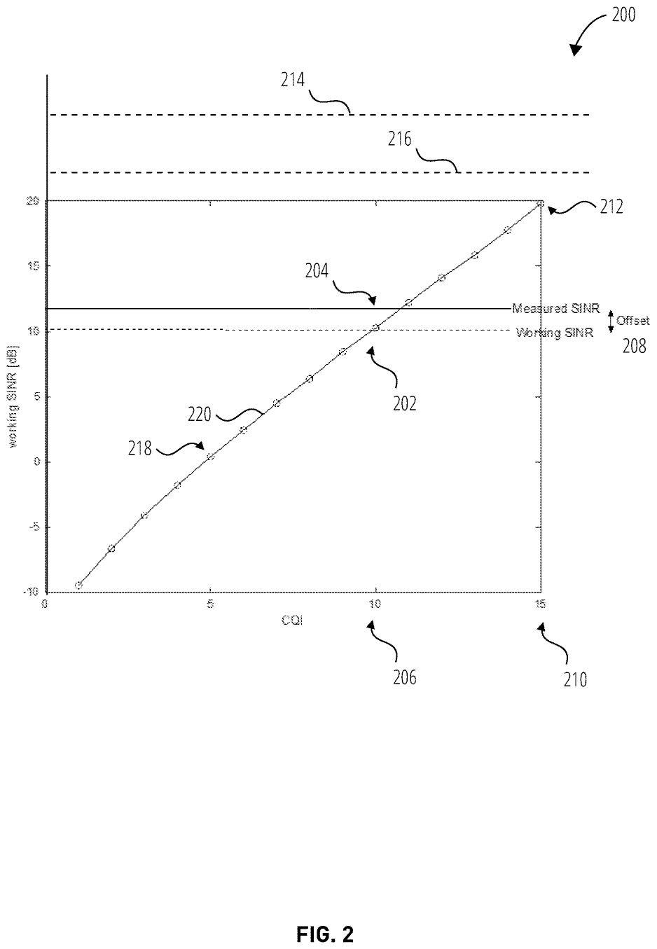

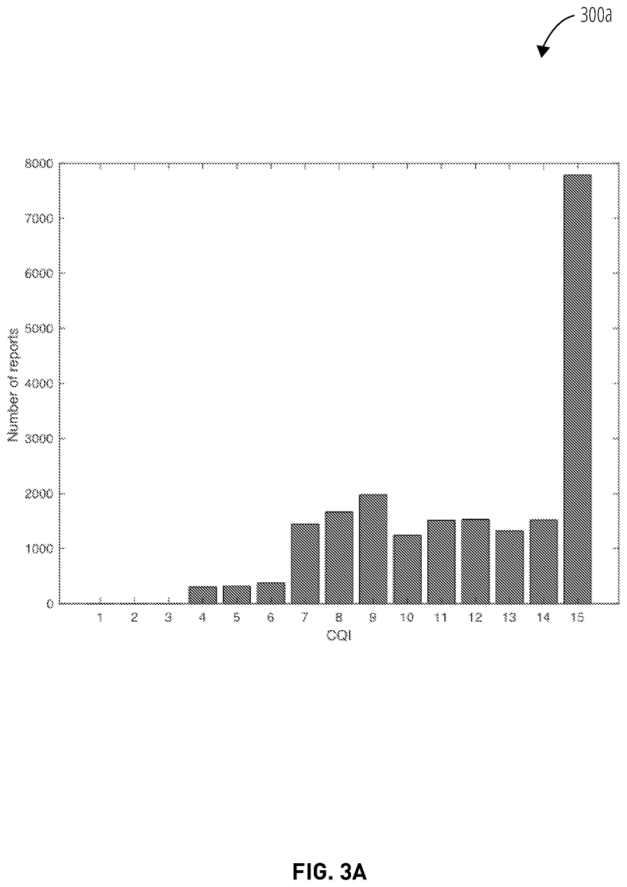

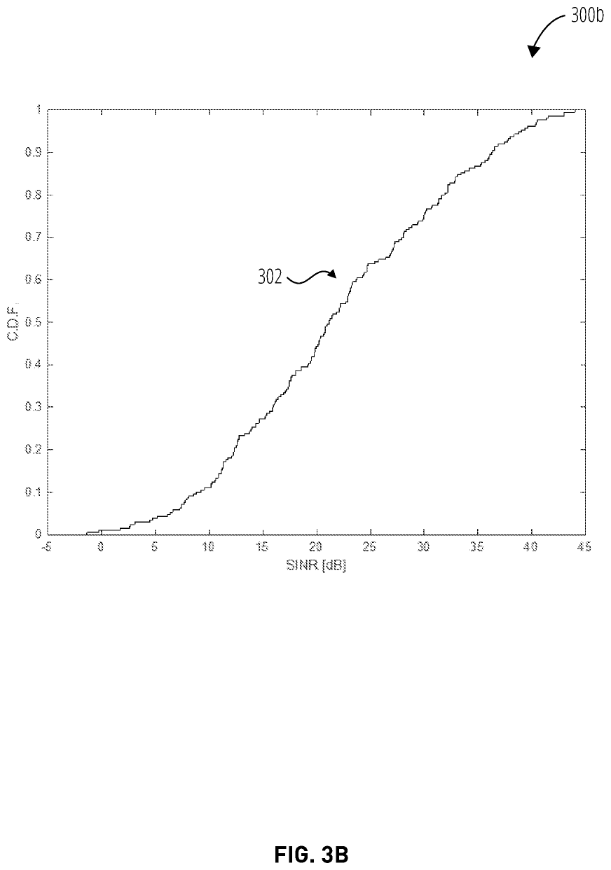

Various aspects of this disclosure relate to power allocation for a physical downlink shared channel (PDSCH) based on channel conditions in a wireless communication system. In some wireless communication systems, the transmission power of the PDSCH is determined by a network entity (such as a base station) based on channel state information (CSI) from the user equipment (UE). Typically, power allocation for the PDSCH is based on a channel quality indicator (CQI) report in the CSI. However, as further described with reference to FIG. 2, FIG. 3A, and FIG. 3B, such techniques may result in a transmission power setting that is higher than needed to support a quality of service on the PDSCH.

This disclosure provides systems, methods, and apparatuses that enable dynamic transmission power allocation for a PDSCH based on additional information from the UE. In some aspects, a channel state information (CSI) report can be modified to include a power backoff indicator (PBI) report that includes one or more PBIs suggested by the UE. The UE may determine the one or more PBIs based on a measured signal-to-interference plus noise ratio (SINR) and a target spectrum efficiency for a reported CQI. In some aspects, the PBI is based on an offset between the measured SINR and a working SINR that satisfies a target block error ratio (BLER) for the reported CQI. The network entity can receive the one or more PBIs from the UE and use the one or more PBIs to set the transmission power of the PDSCH. In some aspects, the network entity can transmit control signaling indicating the transmission power, power offset, or additional power backoff of the PDSCH. In some implementations, the UE and the network entity can implement aspects of this disclosure to reduce transmission power for the PDSCH while still supporting a target quality of service for the PDSCH. The techniques of this disclosure can reduce power allocation, improve system performance by reducing the interference from the PDSCH and reduce network consumption.

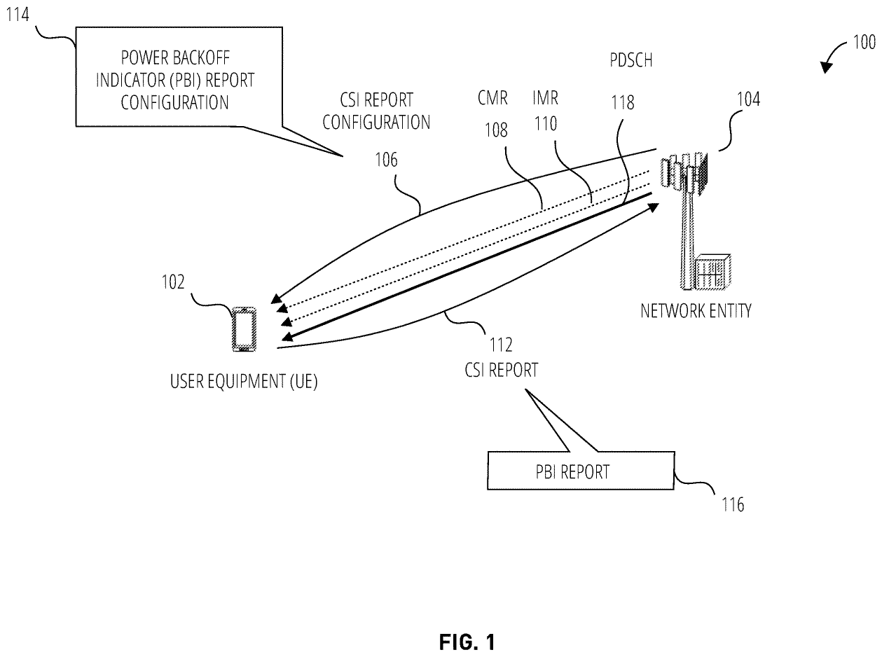

FIG. 1 shows an example of a user equipment (UE) and network entity illustrating power allocation for physical downlink shared channel (PDSCH) according to some aspects of this disclosure. The diagram 100 shows a UE 102 and a network entity 104 of a wireless communication system. The network entity 104 can be a base station. Different types of base stations may be referred to as a NodeB, an LTE evolved NodeB (eNB), a next generation NodeB (gNB), an access point (AP), a radio head, a transmit-receive point (TRP), among other examples, depending on the wireless communication standard that the base station supports. The network entity 104 communicates data to the UE via a PDSCH 118. The PDSCH 118 has a transmission power set by the network entity 104 based on channel conditions. Absent the techniques of this disclosure, the transmission power of the PDSCH 118 is determined based on a CQI obtained from a CSI report 112. For a Multiple-Input Multiple-Output (MIMO) system, the CSI report 112 can provide the key information for a network entity to select the digital precoder for a UE.

A traditional CSI measurement and report technique is described with reference to FIG. 1. Usually, the network entity 104 transmits a CSI report configuration 106 by RRC signaling, such as CSI-ReportConfig, to configure a CSI report. The CSI report configuration 106 can indicate a channel state information reference signal (CSI-RS) that is used as channel measurement resource (CMR 108) for the 102 to measure the downlink channel conditions. Meanwhile, the network entity 104 may configure some interference measurement resource (IMR 110) for UE 102 to measure interference.

By measuring the CMR 108 and the IMR 110, the UE 102 is able to identify the CSI, which may include at least one of rank indicator (RI), precoder matrix indicator (PMI), channel quality indicator (CQI) and layer indicator (LI). RI and PMI are used to indicate the digital precoder. CQI is used to indicate the signal-to-interference plus noise (SINR) status so as to assist the network entity to determine the modulation and coding scheme (MCS). LI is used to identify the strongest layer for the reported precoder indicated by RI and PMI. For a CSI reference signal (CSI-RS) resource, the network entity can configure the power offset between the PDSCH and CSI-RS by an RRC parameter, such as powerControlOffset, and configure the power offset between the CSI-RS and Synchronization Signal Block (SSB) by another RRC parameter, such as powerControlOffsetSS.

The UE 102 measures the CMR 108 and the IMR 110 to determine the CQI. The UE 102 reports the CQI to the network entity 104 in a CSI report 112. For each CQI, the target spectrum efficiency (SE) is predefined. The UE can identify the working signal-to-interference plus noise (SINR) for each CQI, i.e., the SINR that can produce the same block error ratio (BLER) as the target BLER threshold. When reporting a CQI, the UE may identify that measured SINR equals to the working SINR for the CQI plus an offset. The CQI can be a number (such as from 0 to 15) that informs the network entity 104 that the measured SINR satisfies a threshold for working SINR of a particular CQI. The UE 102 is expected to report the highest CQI satisfied by the measured SINR.

In a traditional system, the network entity 104 sets the transmission power (or a power backoff) based on the CQI without regard to how high or low the measured SINR is relative to the working SINR for a particular CQI. Some UEs may have better channel conditions or require even less power to achieve the desired QoS for the PDSCH 118 than would typically be selected for a particular CQI. Current CSI measurement and report only supports CQI report, and does not enable the UE 102 to report any indication on the offset between measured SINR and working SINR to assist the network entity to determine the transmission power backoff for PDSCH 118. If the network entity 104 can be made aware the offset between the measured SINR and working SINR or a suggested power backoff that satisfies the CQI, it is possible that the network entity 104 can transmit the downlink signal with lower power to reduce the interference from the PDSCH.

In some aspects of this disclosure, the network entity 104 can include a PBI Report Configuration 114 in the CSI report configuration 106. For example, the UE 102 can inform the network entity 104 that the UE 102 is capable of reporting one or more PBIs in a PBI report 116. The PBI report 116 can be included in the CSI report 112 to inform the network entity 104 of a power backoff that satisfies the reported CQI. This disclosure includes several example implementations of a CSI report configuration 106 and PBI report configuration 114. For example, the network entity 104 can configure a constraint to limit the candidate CQIs for the UE 102 to consider. In another example, the CSI report configuration 106 can configure multiple CSI-RS resources with different transmission power offsets and request the UE 102 to measure and report either aggregate or detailed PBI information for the CSI-RS resources. In some implementations, the network entity 104 can configure a subband CQI and request subband PBIs via the CSI report configuration 106. Furthermore, the PBI report 116 may include one or more PBIs (or subband PBIs) per CSI-RS resource, per codeword, or both. Alternatively, or additionally, the PBI report 116 may include a PBIs (or subband PBIs) that are an aggregate PBI across all CSI-RS resources, all codewords, or both.

The network entity 104 can set the transmission power of the PDSCH 118 based on the PBI report 116. Absent the techniques of this disclosure, the network entity 104 cannot dynamically change the transmission power for the PDSCH based on the received CSI, since the power offset between PDSCH and CSI-RS, the power offset between the CSI-RS and SSB, and the transmission power for the SSB are configured by RRC signaling by the network entity 104. In some aspects of this disclosure, the network entity 104 can transmit control signaling to inform the UE 102 of the transmission power (or a power backoff) of the PDSCH 118. For example, in some implementations, the network entity 104 can transmit a media access control (MAC) control element (CE) or downlink control information (DCI) that indicates the transmission power or additional power backoff for the PDSCH 118. For example, the MAC CE or DCI may indicate a transmission power offset between the at least one CSI-RS resource and PDSCH, a transmission power offset between the at least one CSI-RS resource and synchronization signal block (SSB), a transmission power of at least one SSB, an additional power backoff for the PDSCH 118, an additional power backoff for the at least one CSI-RS resource, an additional power backoff for the at least one SSB, or any combination of these. Using the information in the MAC CE or DCI, the UE 102 can adjust its receiver (such as the Automatic Gain Control (AGC)) to properly receive the PDSCH 118 using the PDSCH transmission power (or power backoff) set by the network entity 104.

Thus, this disclosure includes various methods and techniques for dynamic transmission power allocation for PDSCH. These include PBI Report Configuration 114 and PBI report 116 for requesting and obtaining PDSCH transmission power backoff indicators from the UE 102. Furthermore, the methods and techniques of this disclosure enable the communication of control signaling for dynamic transmission power allocation for PDSCH. The described solutions can have the advantageous result of reduced power allocation for PDSCH, so that the network entity 104 can improve the system performance, reduce the interference from the PDSCH and reduce the network power consumption.

FIG. 2 illustrates an example SINR measurement and reported CQI. A graph 200 shows one example for the SINR measurement and CQI report. In the graph 200, the vertical axis is working SINR (in decibels (dB)) and the horizontal axis is CQI values. Plot points (such as point 218 at CQI=5 and working SINR=0 dB) indicate the CQI value that corresponds with a particular working SINR. A plot line 220 is shown for ease of reference. In the example illustrated in FIG. 2, a measured SINR 204 (such as 12 dB) is above the working SINR 202 (such as 10 dB) having a corresponding CQI=15 plus an offset 208 (such as 2 dB). In this example, the UE would report CQI=10 (shown at CQI 206). When transmitting the PDSCH based on the SE indicated by the CQI, the network entity can apply a certain power backoff, such as a power backoff smaller than or equal to the offset 208. Such power backoff can reduce the interference to other UEs and reduce the power consumption for the network entity.

In some cases the measured SINR could be so large that the UE reports the maximum CQI, such as CQI=15. For example, a cell center UE may measure a very large SINR. The working SINR 212 for CQI=15 (shown at CQI 210) may be 20 dB as shown in the graph 200. However, the same CQI 210 would be reported regardless if the measured SINR was a first measured SINR 214 or a second measured SINR 216 because both the first measured SINR 214 and the second measured SINR 216 are above the working SINR 212 for the highest CQI value of 15. Absent the techniques of this disclosure, the network entity would limit its power backoff to the predefined offset amount for CQI=15. Using the techniques of this disclosure, the UE can report the power backoff that could be used based on the measured SINR while still satisfying the reported CQI.

FIG. 3A illustrates an example for CQI distribution chart 300a from system level simulation. In the CQI distribution chart 300a, the vertical axis is the number of reports (such as CSI reports) and the horizontal axis is CQI values. Each bar in the CQI distribution chart 300a indicates the number of reports that include a particular CQI value. As shown in the CQI distribution 300a, many CQI reports indicate CQI=15. It is desirable to reduce transmission power for the PDSCH to reduce interference. However, current techniques for power backoff are limited because the offset is predefined for each CQI. The techniques of this disclosure enable a UE to transmit a PBI report that indicates the power backoffs that could be used by the network entity, particularly when the maximum CQI (CQI=15) is reported or when greater granularity is needed than currently possible with the offsets defined for each CQI.

FIG. 3B illustrates an example for geometry SINR distribution graph 300b from system level simulation. In the geometry SINR distribution graph 300b, the vertical axis is cumulative distribution function (CDF) and the horizonal axis is SINR (in dBs). A plot line 302 indicates the CDF at various amounts of SINR.

For high SINR users, the difference between the measured SINR and working SINR could be big. It is possible that the network entity can transmit the downlink signal with power backoff (such as a larger power backoff than normally associated with each CQI) while still resulting in a measured SINR that satisfies the working SINR for a particular CQI. Using a larger power offset would have desirable results of reducing the interference from the PDSCH and reducing network power consumption.

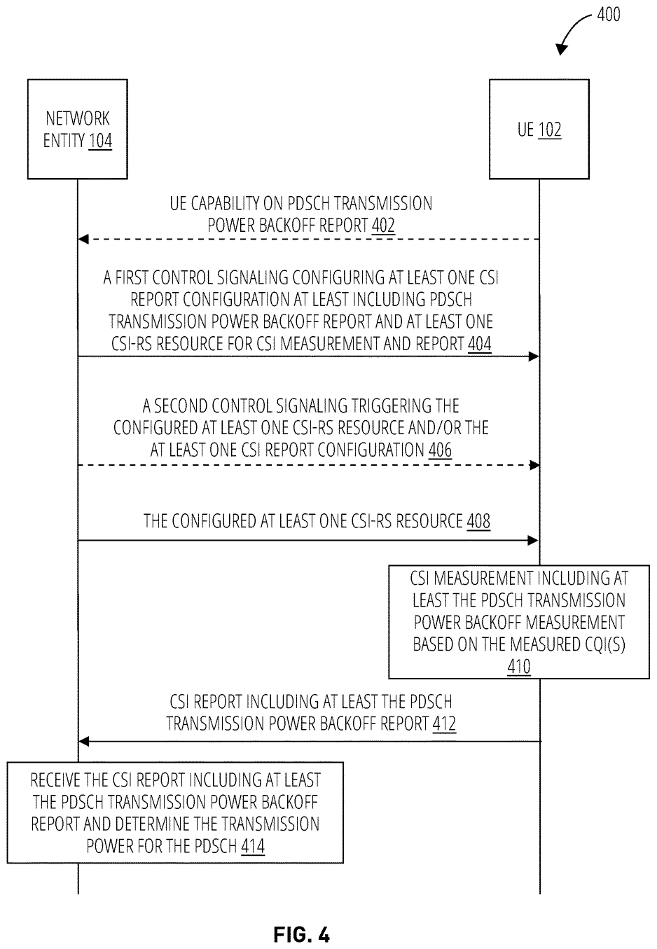

FIG. 4 illustrates an example message flow and procedure 400 in which a CSI report includes a PBI report. The UE 102 can report the UE capabilities 402 at least indicating whether it supports CSI report with PDSCH transmission power backoff report. Based on the received UE capabilities, the network entity 104 transmits a first control signaling 404 configuring at least one CSI report configuration for CSI report with PBI report and at least one CSI-RS resource for CSI measurement. The network entity 104 can transmit the first control signaling 404 by RRC signaling, such as RRCReconfiguration or CSI-ReportConfig. In some implementations, for semi-persistent CSI-RS and/or CSI report or aperiodic CSI-RS and/or CSI report, the network entity 104 can transmit a second control signaling 406 triggering the configured at least one CSI-RS resource and/or the at least one CSI report configuration 406. For example, the second control signaling 406 may be a MAC CE or DCI, triggering the CSI-RS and/or CSI report. Then, the network entity 104 can transmit the configured at least one CSI-RS resource 408 for CSI measurement and report. The UE 102 can determine the PBI report 410 (sometimes also referred to as transmission power backoff report) based on the measured CQI(s) for one or more than one codeword and the measured SINR from the at least one CSI-RS resource. Then the UE transmits the CSI report 412 with PBI report by PUSCH or PUCCH. The network entity 104 receives the CSI report and determines the transmission power for the PDSCH 414 based on the PBI report.

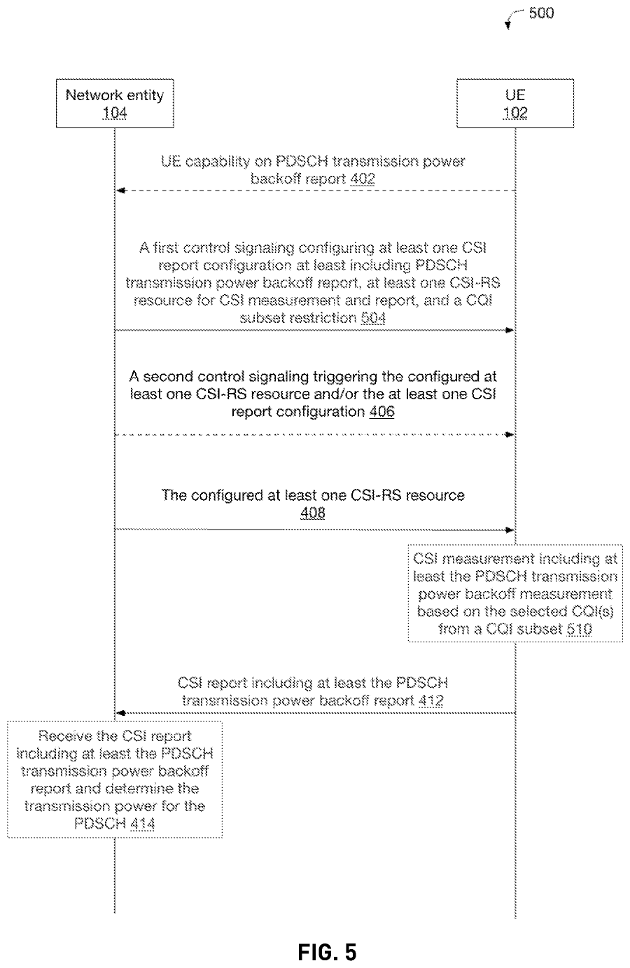

FIG. 5 illustrates an example message flow and procedure 500 in which a CSI report includes a PBI report based on a CQI subset restriction. Compared to the procedure 400 in FIG. 4, the difference is that in FIG. 5, the network entity 104 additionally configures a CQI subset restriction in the first control signaling 504. Then the UE 102 selects the CQI from the configured CQI subset, determines the PBI 510 based on the selected CQI(s) for at least one codeword and measured SINR from the at least one CSI-RS resource and reports the PBI 510 in the CSI report 412.

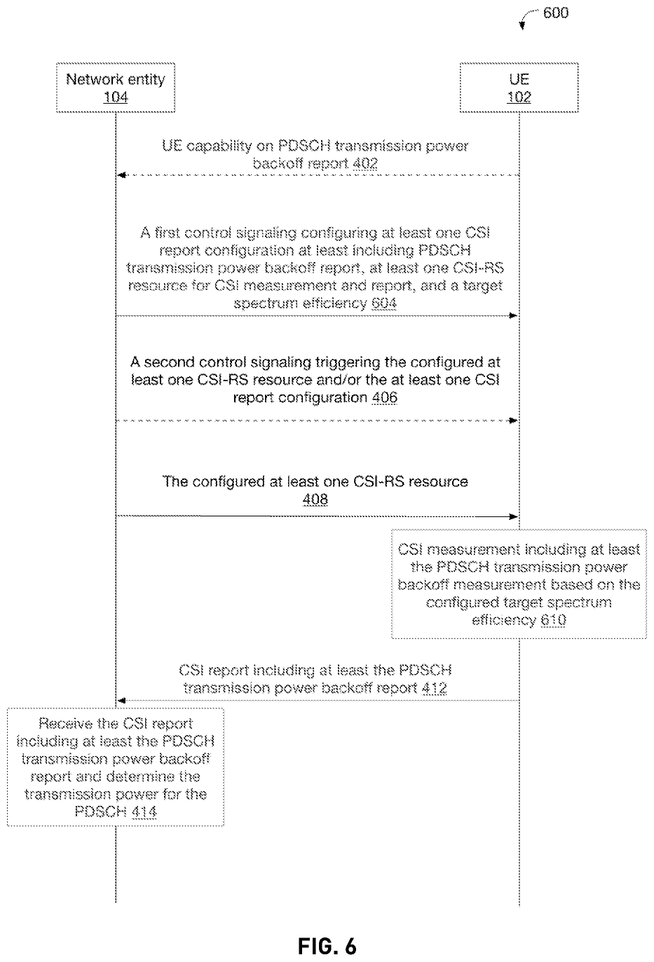

FIG. 6 illustrates an example message flow and procedure 600 in which a CSI report includes a PBI report based on a target spectrum efficiency. Compared to the procedure 400 in FIG. 4, the difference is that in FIG. 6, the network entity 104 additionally configures at least a target spectrum efficiency (SE) in the first control signaling 604. Then the UE determines the PBI 610 based on the configured target SE and the measured SINR from the at least one CSI-RS resource and reports the PBI 610 in the CSI report 412.

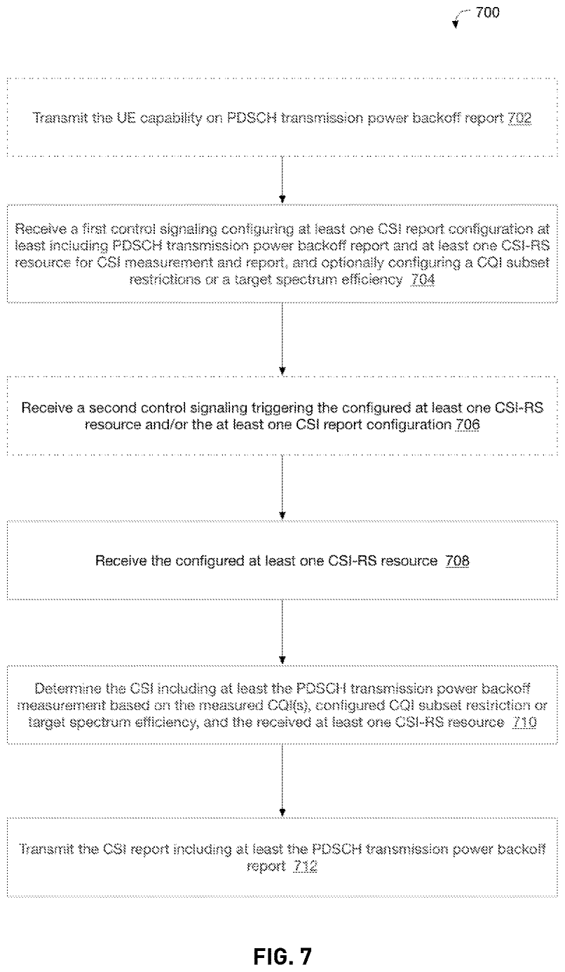

FIG. 7 illustrates an example process 700 for a UE that supports the PBI report according to some aspects of this disclosure. At block 702, the UE may transmit the UE capability on PDSCH transmission power backoff report. At block 704, the UE receives a first control signaling configuring at least one CSI report configuration at least including PDSCH transmission power backoff report (such as PBI report) and at least one CSI-RS resource for CSI measurement and report, and optionally configuring a CQI subset restrictions or a target spectrum efficiency. At block 706, the UE may receive a second control signaling triggering the configured at least one CSI-RS resource and/or the at least one CSI report configuration. At block 708, the UE receives the configured at least one CSI-RS resource. At block 710, the UE determines the CSI including at least the PDSCH transmission power backoff measurement based on the measured CQI(s), configured CQI subset restriction or target spectrum efficiency, and the received at least one CSI-RS resource. At block 712, the UE transmits the CSI report including at least the PDSCH transmission power backoff report.

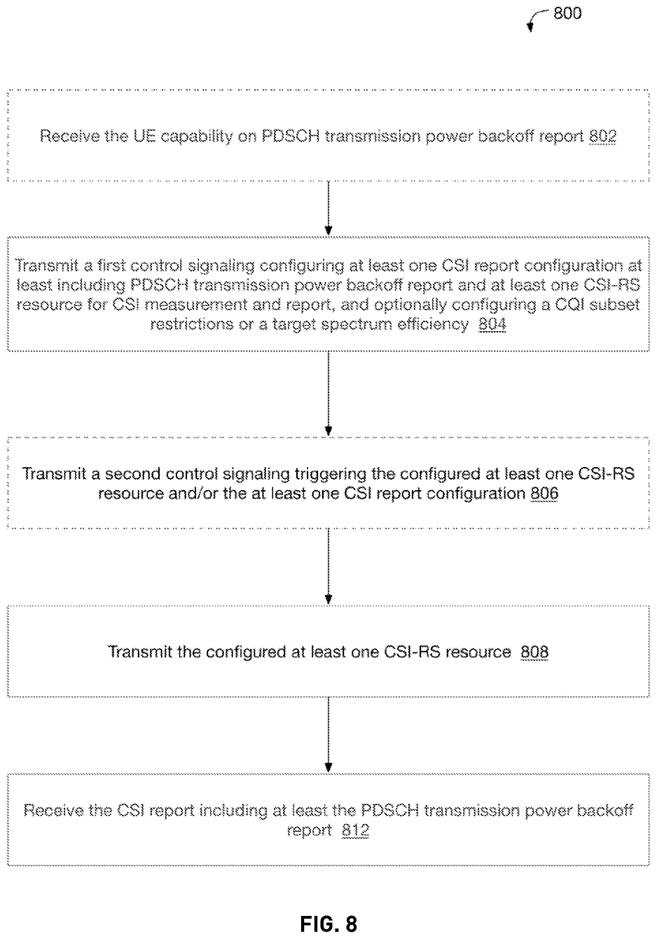

FIG. 8 illustrates an example process 800 for a network entity that supports the PBI report according to some aspects of this disclosure. At block 802, the network entity may receive the UE capability on PDSCH transmission power backoff report. At block 804, the network entity transmits a first control signaling configuring at least one CSI report configuration at least including PDSCH transmission power backoff report (such as PBI report) and at least one CSI-RS resource for CSI measurement and report, and optionally configuring a CQI subset restrictions or a target spectrum efficiency. At block 806, the network entity may transmit a second control signaling triggering the configured at least one CSI-RS resource and/or the at least one CSI report configuration. At block 808, the network entity transmits the configured at least one CSI-RS resource. At block 812, the network entity receives the CSI report including at least the PDSCH transmission power backoff report 812.

In this disclosure, unless specified, a RRC signaling indicates a RRC reconfiguration message from the network entity to UE, or a System Information Block (SIB), where the SIB can be an existing SIB (such as SIB1) or a new SIB (such as SIB J, where J is an integer above 21) transmitted by gNB.

In this disclosure, unless specified, the network entity may receive the UE capability from a UE or from a core network (such as Access and Mobility Management Function (AMF)) or another network entity.

In some implementations, the UE can transmit the UE capability on CSI report with PBI report indicating at least one of the elements: whether the UE supports PBI report; the maximum number of configured CSI-RS resources for PBI report; the maximum number of CSI-RS resources in a slot for PBI report. The UE capabilities above can be counted per component carrier (CC), across all the CCs in a band or band combination, or across all the CCs in a UE.

### PBI Measurement and Report and Relevant Control Signaling

### Option 1-1: PBI Report Based on Reported CQI(s)

In some implementations, the UE determines the PBI based on the measured SINR and at least one reported CQI. The UE determines the working SINR for the reported CQI. The network entity configures the CSI report including a PBI report by the first control signaling. In one example, the network entity configures the PBI report by configuring the reportQuantity as cri-RI-PMI-CQI-PBI, cri-RI-i1-CQI-PBI, cri-RI-CQI-PBI, or cri-RI-LI-PMI-CQI-PBI, which indicate the UE should report PBI in addition to other CSI components, such as CRI, RI, PMI or part of PMI (such as the first PMI, i1), CQI and/or LI. In another example, the network entity configures the PBI report by configuring a separate RRC parameter, such as enablePbiReport.

In some implementations, the UE can identify the offset between the measured SINR and working SINR for the reported CQI.

In one example, the offset is calculated as shown in formula (1):

$$offset = {SINR}_{m} - {SINR}_{w} \qquad ( 1 )$$

Where SINRₘ indicates the measured SINR in the unit of dB, and for multi-layer transmission, it indicates the average SINR across the layers; SINR_{w} indicates the working SINR for the reported CQI in the unit of dB, and for multi-layer transmission, it indicates the average SINR across the layers.

In another example, the offset is calculated as shown in formula (2):

$$offset = {SINR}_{w} - {SINR}_{m} \qquad ( 2 )$$

Then the UE reports the PBI to quantize the offset. In some implementations, the step size for every two PBI is predefined. In one example, the UE reports the PBI by 3 bits, and the indication of the 3-bit PBI could be as Table 1. In some other implementations, the network entity configures the step size for every two PBI by RRC signaling or MAC CE. In some other implementations, the UE reports the step size for every two PBI by the CSI report or a separate report.

TABLE 1
An example for PBI indication

| PBI | Recommended offset | |
|---|---|---|
| 000 | 0.0 | dB |
| 001 | −0.5 | dB |
| 010 | −1.0 | dB |
| 011 | −1.5 | dB |
| 100 | −2.0 | dB |
| 101 | −2.5 | dB |
| 110 | −3.0 | dB |
| 111 | −3.5 | dB |

In some other implementations, the UE can identify the offset between the measured SINR, working SINR for the reported CQI and the latest reported offset.

In one example, the offset is calculated as shown in formula (3):

$$offset = {SINR}_{m} - {SINR}_{w} + {offset}^{′} \qquad ( 3 )$$

Where SINRₘ indicates the measured SINR in the unit of dB; SINR_{w} indicates the working SINR for the reported CQI in the unit of dB; offset′ indicates the latest reported offset for the same CSI report configuration, and if the latest reported CQI is different from currently determined CQI, offset′=0 dB.

In another example, the offset is calculated as shown in formula (4):

$$offset = {SINR}_{w} - {SINR}_{m} + {offset}^{′} \qquad ( 4 )$$

Then the UE reports the PBI to quantize the offset. In some implementations, the step size for every two PBI is predefined. In one example, the UE reports the PBI by 3 bits, and the indication of the 3-bit PBI could be as Table 2. In some other implementations, the network entity configures the step size for every two PBI by RRC signaling or MAC CE. In some other implementations, the UE reports the step size for every two PBI by the CSI report or a separate report.

TABLE 2
An example for PBI indication

| PBI | Recommended offset | |
|---|---|---|
| 000 | 2.0 | dB |
| 001 | 1.5 | dB |
| 010 | 1.0 | dB |
| 011 | 0.5 | dB |
| 100 | 0.0 | dB |
| 101 | −0.5 | dB |
| 110 | −1.0 | dB |
| 111 | −1.5 | dB |

### Option 1-1a: Single PBI Report Per CSI Report

In some implementations, for a CSI report, the UE transmits a single PBI and other CSI by PUCCH or PUSCH.

In some implementations, the network entity configures the UE to report one CQI per subband, the UE calculates the offset for each subband based on the subband CQI and measured SINR per subband, and reports the PBI calculated based on the minimum, maximum or average offset across all the subbands. In some other implementations, the network entity configures the UE to report one CQI per subband, the UE calculates the offset based on the wideband CQI and the wideband measured SINR, and reports the wideband PBI based on the wideband offset.

In some implementations, the UE reports CQIs for more than one codewords. The UE may report the PBI based on the offset from one codeword. In some implementations, the UE reports the PBI based on the CQI from the first or last codeword. In some other implementations, the UE reports an indicator indicating the codeword index to determine the PBI. In some other implementations, the UE reports the PBI based on the CQI from the codeword with the smallest or largest spectrum efficiency or CQI.

In some other implementations, the UE reports CQIs for more than one codewords. The UE may report the PBI based on the offset from all the codewords. The UE may report the PBI corresponding to the maximum or minimum or average offset across all the codewords.

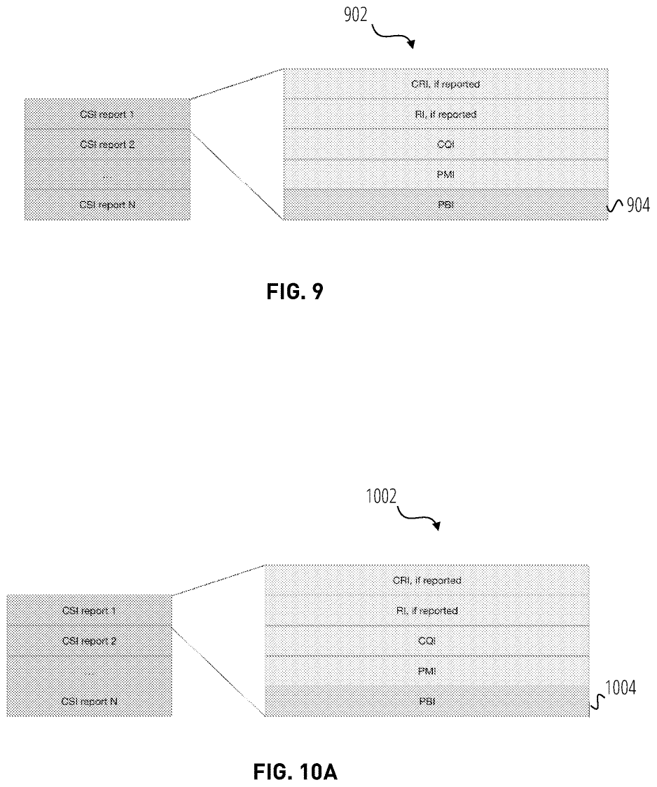

FIG. 9 illustrates an example PBI report in short physical uplink control channel (PUCCH). For short PUCCH, such as PUCCH with less than or equal to 4 symbols, the UE transmits the PBI 904 and other CSI (such as CRI, if reported, RI, if reported, CQI, PMI) in a single part 902.

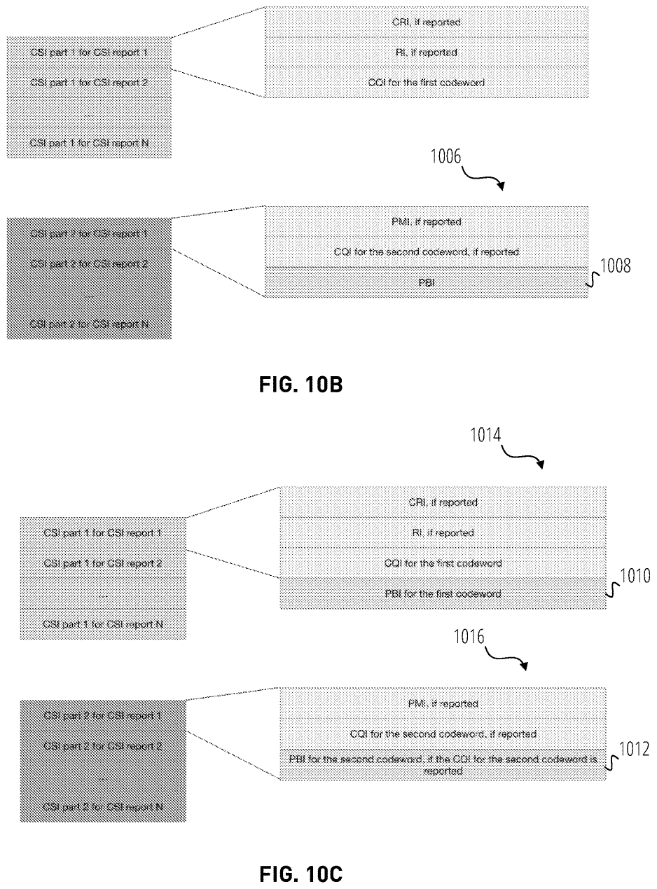

FIG. 10A illustrates an example PBI report in CSI part 1 in long PUCCH or physical uplink shared channel (PUSCH). For long PUCCH, such as PUCCH with more than 4 symbols, and PUSCH, the UE transmits the PBI 1004 in CSI part 1 or CSI part 2. FIG. 10A illustrates an example for the CSI report with PBI in long PUCCH or PUSCH, where the PBI 1004 is in CSI part 1 1002.

FIG. 10B illustrates an example PBI report in long PUCCH or PUSCH. In the example shown in FIG. 10B, the PBI 1008 is included in CSI part 2 1006.

### Option 1-1b: PBI Report Per Codeword

FIG. 10C illustrates an example PBI report in CSI part 1 and CSI part 2 in long PUCCH or PUSCH. A first portion of the PBI 1010 is included in CSI part 1 1014 and a second portion of the PBI 1012 is included in the CSI part 2 1016.

In some implementations, for a CSI report, the UE transmits a single PBI per codeword and other CSI by PUCCH or PUSCH. Compared to option 1-1a, the difference is that in option 1-1b, the UE reports more than one PBI in a CSI report, where each PBI corresponds to a codeword. The UE determines a PBI based on the measured SINR and working SINR for the reported CQI(s) for the corresponding codeword.

In some implementations, when reporting the PBI(s) by PUSCH or long PUCCH, the UE reports all the PBI(s) in CSI part 1 or CSI part 2, as FIG. 9, FIG. 10A, FIG. 10B. In some other implementations, when reporting the PBI(s) by PUSCH or long PUCCH, the UE may report some of the PBI(s) in CSI part 1 and the other PBI(s) in CSI part 2. The PBI in CSI part 1 corresponds to the CQI(s) in CSI part 1, and the PBI in CSI part 2 corresponds to the CQI(s) in CSI part 2. The network entity and the UE determines the presence of the PBI in CSI part 2 based on the presence of the CQI in CSI part 2. In one example, if the UE needs to report the CQI for the second codeword in CSI part 2, the UE reports the PBI for the second codeword.

### Option 1-1c: PBI Report Per Subband

In some implementations, for a CSI report, the UE transmits a single PBI per subband and other CSI by PUCCH or PUSCH. Compared to option 1-1a, the difference is that in option 1-1c, the UE reports more than one subband PBI in a CSI report. The UE determines a subband PBI based on the measured SINR for the subband and working SINR for the reported CQI(s) for the corresponding subband.

In some implementations, the network entity configures the subband(s) for the PBI report by the first control signaling or the second control signaling. In some implementations, the network entity configures the same subband(s) for subband PBI report and subband PMI/CQI. The network entity may configure the subband(s) for PBI report and subband PMI/CQI by a common RRC parameter, such as CSI-ReportingBand. In some other implementations, the network entity configures different subbands for subband PBI report compared to the subbands for the subband PMI/CQI. In one example, the network entity configures the subbands for PBI report by a separate RRC parameter, such as pbi-ReportingBand. In another example, the network entity configures the subbands for PBI report based on the subbands configuration for PMI/CQI by a RRC parameter indicating number of subbands per PBI, such as nrofSubbandsPerPbi, or number of PBIs per subband or per CQI, such as nrofPbiPerSubband or nrofPbiPerCqi.

### Option 1-1d: PBI Report Per Subband Per Codeword

In some implementations, for a CSI report, the UE transmits a single PBI per subband per codeword and other CSI by PUCCH or PUSCH. Compared to option 1-1a/1-1b/1-1c, the difference is that in option 1-1d, the UE may report more than one subband PBI for each codeword in a CSI report. The UE determines a subband PBI for a codeword based on the measured SINR for the subband and working SINR for the reported CQI(s) for the corresponding subband and codeword.

### Option 1-1e: Configurable PBI Report Granularity

In some implementations, the network entity configures the granularity for PBI report in a CSI report by the first control signaling or the second control signaling. Compared to option 1-1a/1-1b/1-1c/1-1d, the difference is that in option 1-1e, the network entity configures whether the UE shall report the PBI per subband or wideband, and/or report the PBI per codeword or across codewords. In some implementations, the UE may further report the supported granularity for PBI report, such as whether it supports wideband PBI report or subband PBI report, and/or whether it supports PBI report per codeword or across codewords.

Option 1-2: PBI Report Only when the Reported CQI is the Maximum CQI

In some implementations, the UE reports the PBI only when its reported CQI is the maximum CQI. Compared to option 1-1, the difference is that in option 1-2, the UE does not report PBI or report a default value of PBI, such as ‘000’, if the corresponding CQI for the PBI report is not the maximum CQI, such as CQI=15.

In some implementations, based on the traffic type and some prior reports, such as layer 3 reference signal received power (L3-RSRP) or layer 3 SINR (L3-SINR), the network entity may identify candidate values for the potential spectrum efficiency. The network entity may configure the maximum CQI for a CSI report by RRC signaling or MAC CE. The network entity may configure the maximum CQI per RI, per codeword or across codewords.

In some other implementations, the network entity configures a CQI subset restriction for a CSI report by RRC signaling or MAC CE. The network entity may configure the CQI subset restriction per RI, per codeword or across codewords. In one example, the network entity configures the CQI subset restriction based on a bitmap, such as 16-bit bitmap. Where value “1” for bit x indicates CQI=x is valid for CSI report, and value “0” for bit x indicates CQI=x is invalid for CSI report. For CQI report, the UE should report the CQI based on the valid CQIs based on the configured CQI subset restriction. The bit-width for the absolute CQI is determined based on the number of valid CQIs. In one example, the bit-width is calculated as ceil (log, K), where K indicates the number of valid CQIs.

### Option 1-3: PBI Report Based on the Target SE

In some implementations, the UE reports the PBI based on the measured SINR and a target SE and reported RI, such as number of layers. Compared to option 1-1, the difference is that in option 1-3, the UE determines the PBI based on offset between the measured SINR and the working SINR for a target SE on the reported number of layers.

In some implementations, the network entity configures a wideband target SE for a CSI report configuration. The UE can identify the target SE per layer based on the target SE and the number of layers indicated by the reported RI. Then the UE can identify the working SINR for the target SE per layer, and calculates the offset between the measured SINR and working SINR.

In some other implementations, the network entity configures a target SE per subband. The UE can identify the target SE per layer for each subband based on the target SE per subband and the number of layers indicated by the reported RI. Then the UE can identify the working SINR per subband based on the target SE per layer per subband, and calculates the offset between the measured SINR and working SINR for each subband.

In some implementations, the UE reports one default state of PBI, such as ‘000’, if it identifies the measured SINR is lower than the working SINR for the configured target SE. In some other implementations, the UE does not report the PBI, if it identifies the measured SINR is lower than the working SINR for the configured target SE. In some other implementations, the UE reports a PBI recommending the network entity to increase the transmission power to meet the target SE, if it identifies the measured SINR is lower than the working SINR for the configured target SE.

### Option 1-4: PBI Report Based on Multiple CSI Hypothesis

In some implementations, the network entity configures multiple power offsets between the PDSCH and CSI-RS for CSI report. The UE may report the CSI recommending one of the power offsets. Alternatively, the UE may report the CSI for each power offsets and the network entity can select the corresponding power offsets and MCS for PDSCH transmission based on the received CSIs.

Option 1-4a: Implicit PBI Report Based on Power Offset Report from a List of Candidate Power Offsets

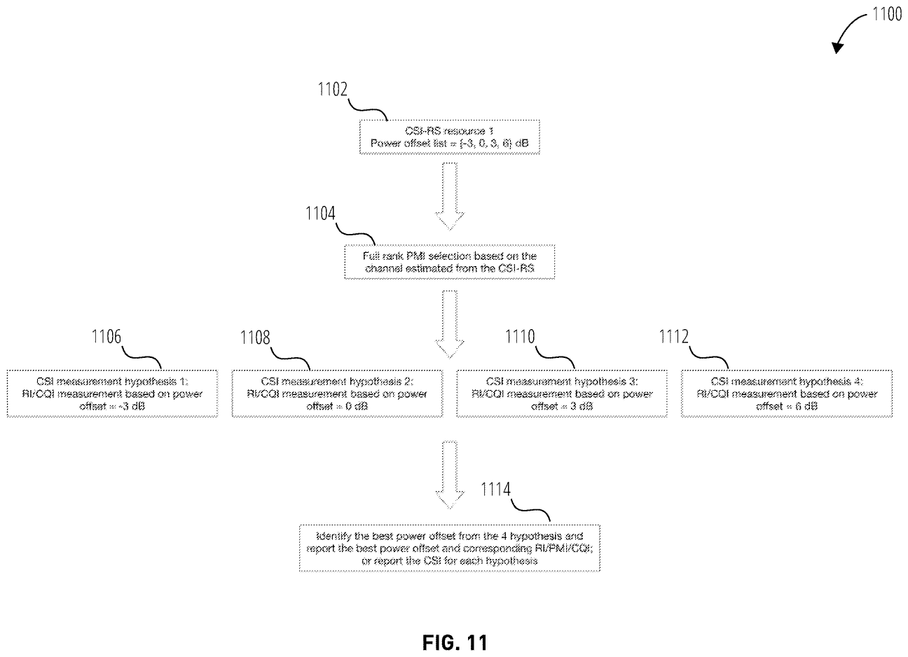

FIG. 11 illustrates an example process 1100 for generating PBI report based on multiple candidate power offsets. In some implementations, the network entity configures a list of power offsets for a CSI-RS resource for CSI report by RRC signaling or MAC CE (block 1102). In the example shown in FIG. 11, the UE determines the full rank PMI selection based on the channel estimated from the CSI-RS (block 1104). The UE can generate CSI measurement hypotheses for various power offsets. For example, at block 1106, the UE generates a first CSI measurement hypothesis (CSI measurement hypothesis 1) considering a first RI/CQI measurement based on a first power offset (−3 dB). Similarly, at blocks 1108, 1110, and 1112, the UE generates alternative CSI measurement hypothesis based on different power offsets (such as 0 dB, 3 dB, and 6 dB, respectively). At block 1114, the UE identifies the best power offset based on the respective RI/CQI measurements for the power offsets in each of CSI measurement hypotheses in blocks 1106, 1108, 1110, and 1112.

In some implementations, the UE can report the PBI by reporting one of the candidate power offsets. The UE may report the other CSI, such as RI/PMI/CQI, based on the reported PBI. The UE may select the lowest power offset that can produce the highest SE based on the reported CQI and RI or the lowest SE that exceeds the target SE configured by the RRC signaling or MAC CE from the network entity.

In some other implementations, the UE can report the CQI for each power offset and the network entity can determine the best power backoff based on the reported CSI. In some implementations, the UE reports a common RI/PMI for all the power offsets, and separate CQI for each power offsets. In some other implementations, the UE reports RI/PMI/CQI for each power offsets. In some other implementations, the UE reports a common PMI for full rank, and separate RI/CQI for each power offsets. Then for each RI, the CQI is calculated based on the first N layers from the reported full rank PMI, where N is the number of layers indicated by the reported RI.

In some implementations, the CSI report takes 1 CSI processing unit. In some other implementations, the UE processes the CSI measurement for each hypothesis in parallel, and the CSI report may take M CSI processing units where M is the number of candidate power offsets. In some other implementations, the UE processes the CSI measurements for some hypothesis in parallel, and the CSI report takes K, such as 1<=K<=M, CSI processing units where the UE reports the value of K via UE capability. In some implementations, the UE reports a UE capability indicating the additional processing delay for the CSI report on top of the minimum processing delay for legacy CSI report, such as CSI report based on CSI-RS with a single power offset. Alternatively, the additional processing delay may be predefined or determined based on the number of candidate power offsets, such as 4M symbols.

Option 1-4b: Implicit PBI Report Based on CRI Report from a List of CSI-RS Resources with Different Power Offsets

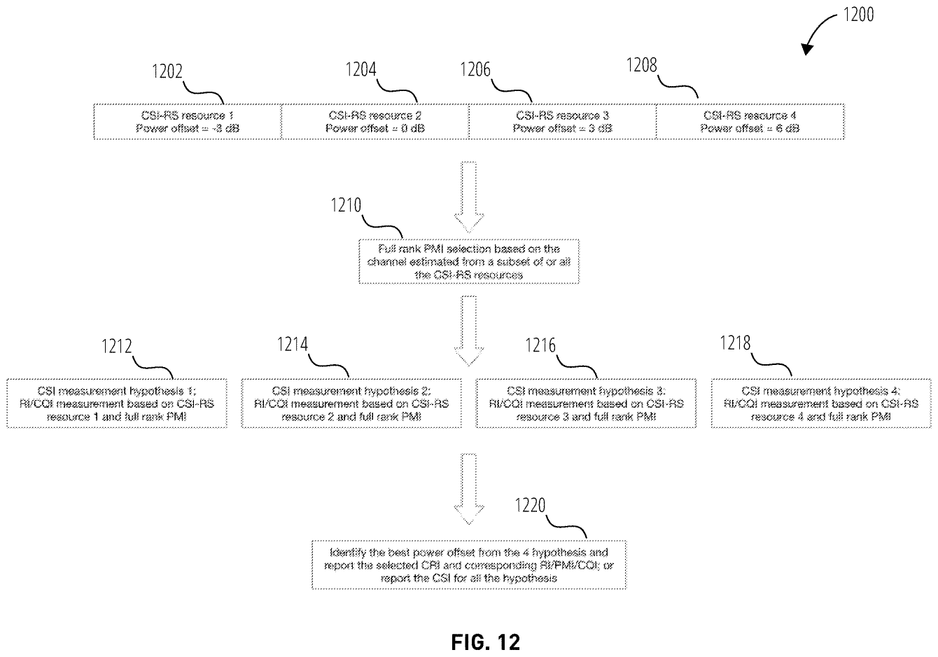

FIG. 12 illustrates an example PBI report based on multiple CSI-RS resources with different power offsets. The network entity configures a list of CSI-RS resources (shown at blocks 1202, 1204, 1206 and 1208) with different power offsets in one or more than one CSI report, where the network entity configures the CSI-RS resources that are from the same antenna port(s) or share the same spatial transmission filter or the same quasi-co-location (QCL) property, and/or with the same bandwidth, and/or frequency domain density. At block 1210, the UE determines the full rank PMI based on the channel estimated from a subset or all of the CSI-RS resources. At blocks 1212, 1214, 1216 and 1218, the UE generates a respective CSI measurement hypothesis for the subset or all of the CSI-RS resources. The CSI measurement hypothesis includes a RI/CQI measurement based on respective CSI-RS resources and the full rank PMI. At block 1220, the UE identifies the best power offset from the CSI measurement hypotheses and reports the CRI of the CSI-RS that provided the best power offset. The UE also reports the RI/PMI/CQI for the CSI-RS indicated by the CRI. In some implementations, the UE can report the CSI for a plurality of CSI measurement hypotheses.

In some implementations, the UE can report the PBI by reporting the CSI-RS resource indicator (CRI). The UE may report the other CSI, such as RI/PMI/CQI, based on the reported CRI. The UE can select the CRI with lowest power offset that can produce the highest SE based on the reported CQI and RI or the lowest SE that exceeds the target SE configured by the RRC signaling or MAC CE from the network entity.

In some implementations, the UE can report the CQI for each CSI-RS and the network entity can determine the best power backoff based on the reported CSI. In some implementations, the UE may report a common RI/PMI for all the CSI-RS resources, and separate CQI for each CSI-RS resource. In some other implementations, the UE may report RI/PMI/CQI for each CSI-RS resource. In some other implementations, the UE may report a common PMI for full rank, and separate RI/CQI for each CSI-RS resource. Then for the CSI-RS resource, the CQI is calculated based on the first N layers from the reported full rank PMI, where N is the number of layers indicated by the reported RI.

In some implementations, the CSI report takes 1 CSI processing unit. In some other implementations, the UE processes the CSI measurement for each hypothesis in parallel, and the CSI report takes M CSI processing units where M is the number of candidate power offsets. In some other implementations, the UE processes the CSI measurements for some hypothesis in parallel, and the CSI report takes K, such as 1<=K<=M, CSI processing units where the UE reports the value of K via UE capability. In some implementations, the UE reports a UE capability indicating the additional processing delay for the CSI report on top of the minimum processing delay for legacy CSI report, such as CSI report based on CSI-RS with a single power offset. Alternatively, the additional processing delay may be predefined or determined based on the number of CSI-RS resources with different power offsets, such as 4M symbols.

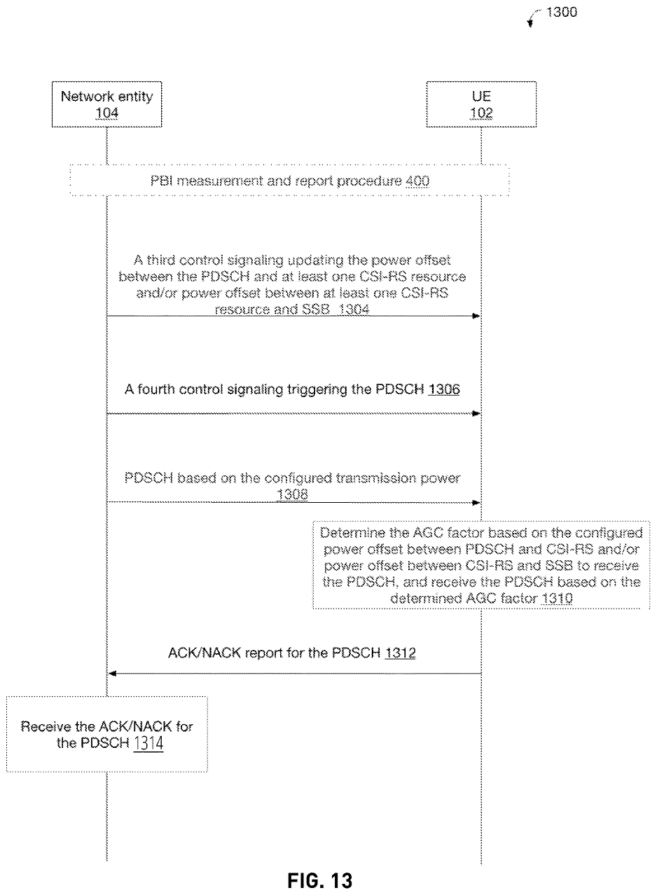

FIG. 13 illustrates a first example message flow and procedure 1300 for dynamic PDSCH power allocation according to some aspects of this disclosure. The UE 102 may report the PBI based on the CSI report framework (such as using the procedures 400, 500 or 600 described with respect to FIGS. 4, 5 and 6, respectively). Based on the received PBI report or some other measurement report or open-loop link adaptation, the network entity 104 transmits a third control signaling 1304 configuring the power offset between the PDSCH and at least one CSI-RS resource and/or the power offset between at least one CSI-RS resource and SSB. In some implementations, the CSI-RS may be quasi-co-located (QCLed) with the PDSCH, such as CSI-RS is configured as the quasi-co-location source reference signal in the Transmission configuration indicator (TCI) state indicated for the PDSCH. The network entity 104 may transmit the third control signaling by MAC CE or DCI. In some implementations, the network entity 104 may transmit a fourth control signaling 1308, such as a DCI, triggering the PDSCH. The network entity 104 transmits the PDSCH 1308 based on the updated power. At block 1310, the UE 102 determines the AGC factor based on the configured transmission power for the PDSCH as indicated in the third control signaling 1304. The configured transmission power can be indicated as a power offset between the PDSCH and the CSI-RS and/or power offset between the CSI-RS and SSB, among other examples. The UE 102 receives the PDSCH using the determined AGC factor. Then the UE 102 transmits an ACK/NACK report 1312 for the PDSCH to the network entity 104. At block 1314, the network entity 104 receives the ACK/NACK report for the PDSCH from the UE 102.

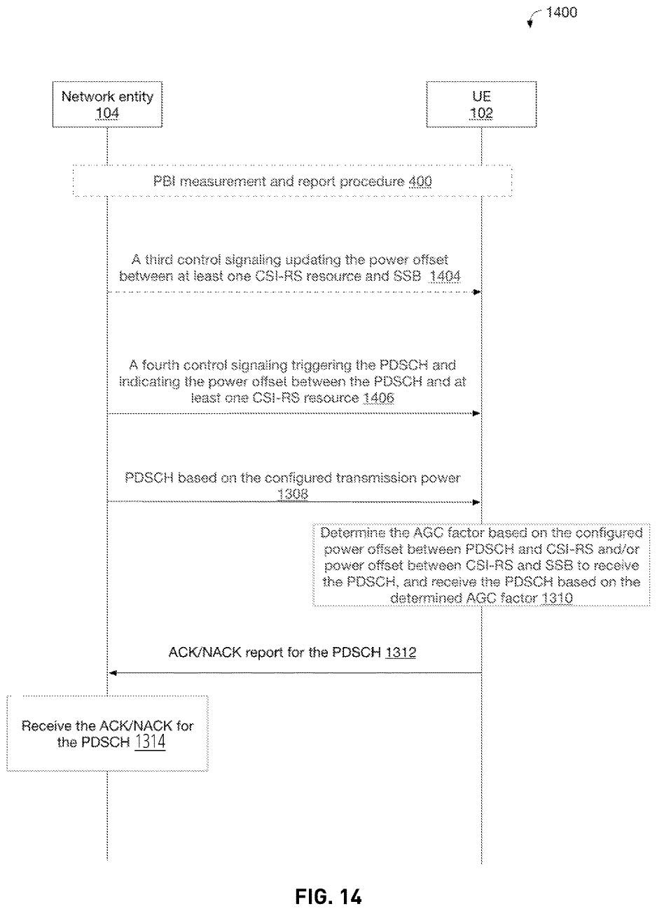

FIG. 14 illustrates a second example message flow and procedure 1400 for dynamic PDSCH power allocation according to some aspects of this disclosure. Compared to the procedure in FIG. 13, the difference is that in FIG. 14, the network entity 104 indicates the power offset between PDSCH and CSI-RS by the fourth control signaling 1406.

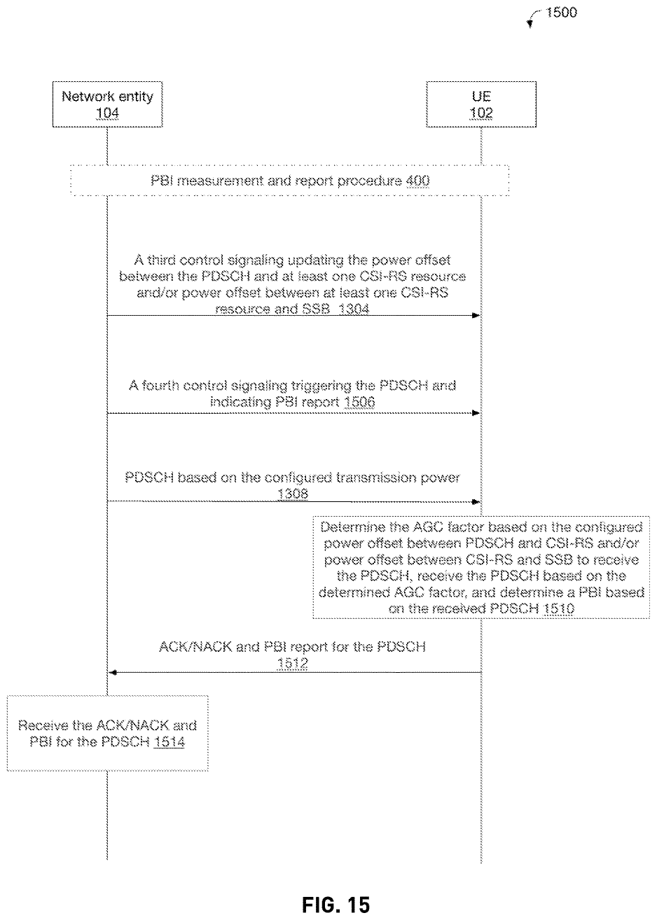

FIG. 15 illustrates a third example message flow and procedure 1500 for dynamic PDSCH power allocation according to some aspects of this disclosure. Compared to the procedure in FIG. 13, the difference is that in FIG. 15, the network entity 104 indicates the UE 102 to report the PBI based on the received PDSCH. As described with reference to FIG. 13, the network entity 104 indicates the transmission power in third control signaling (block 1304) using one or more power offsets. At block 1510, the UE 102 determines the AGC factor based on the configured transmission power for the PDSCH and receives the PDSCH using the determined AGC factor. The UE measures the PBI based on the determined AGC factor and working SINR for PDSCH. The UE 102 reports the PBI 1512 to the network entity in addition to the ACK/NACK report for the PDSCH. At block 1514, the network entity 104 receives the ACK/NACK and the PBI for the PDSCH.

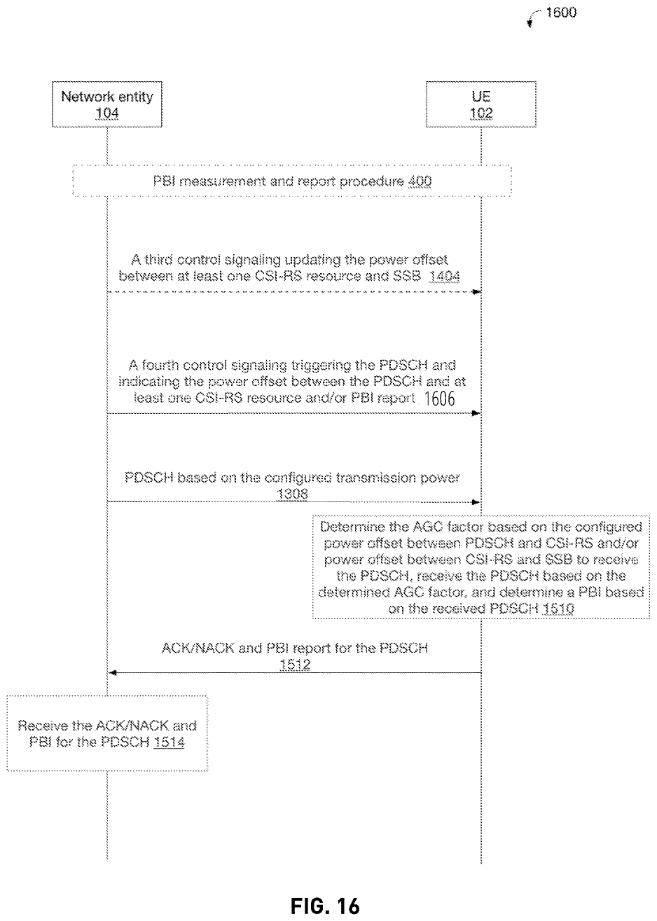

FIG. 16 illustrates a fourth example message flow and procedure 1600 for dynamic PDSCH power allocation according to some aspects of this disclosure. Compared to the procedures in FIG. 14 and FIG. 15, the difference is that in FIG. 16, the network entity 104 indicates the power offset between PDSCH and CSI-RS by the fourth control signaling 1606.

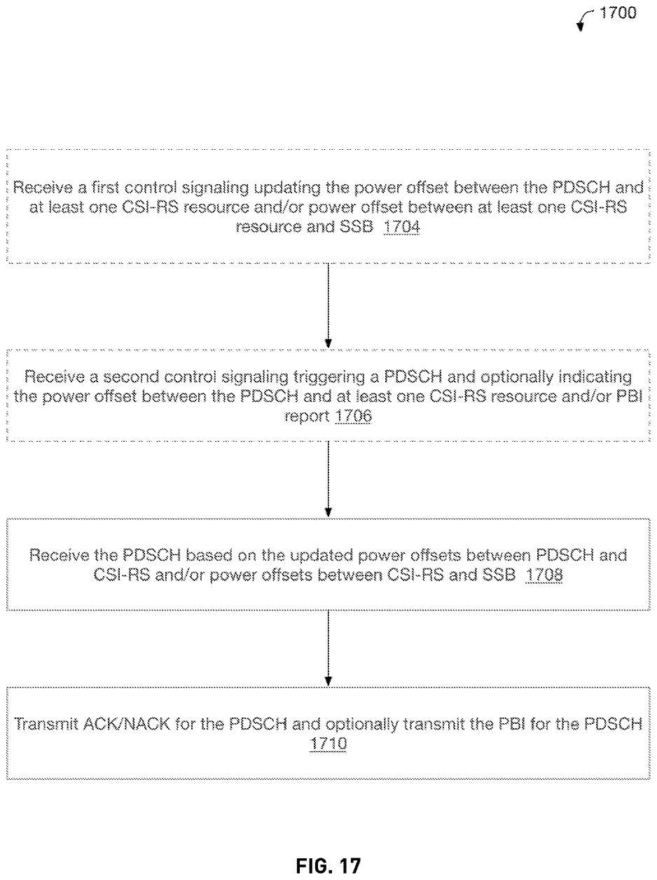

FIG. 17 illustrates an example process 1700 for a UE that supports dynamic PDSCH transmission power allocation according to some aspects of this disclosure. At block 1704, the UE receives a first control signaling updating the power offset between the PDSCH and at least one CSI-RS resource and/or power offset between at least one CSI-RS resource and SSB. At block 1706, the UE receives a second control signaling triggering a PDSCH and optionally indicating the power offset between the PDSCH and at least one CSI-RS resource and/or PBI report. At block 1708, the UE receives the PDSCH based on the updated power offsets between PDSCH and CSI-RS and/or power offsets between CSI-RS and SSB. At block 1710, the UE transmits ACK/NACK for the PDSCH and optionally transmit the PBI for the PDSCH. In some implementations, the UE may transmit the ACK/NACK and the PBI using the same PUCCH or PUSCH resource. Alternatively, UE may transmit the ACK/NACK and the PBI on different PUCCH or PUSCH resources.

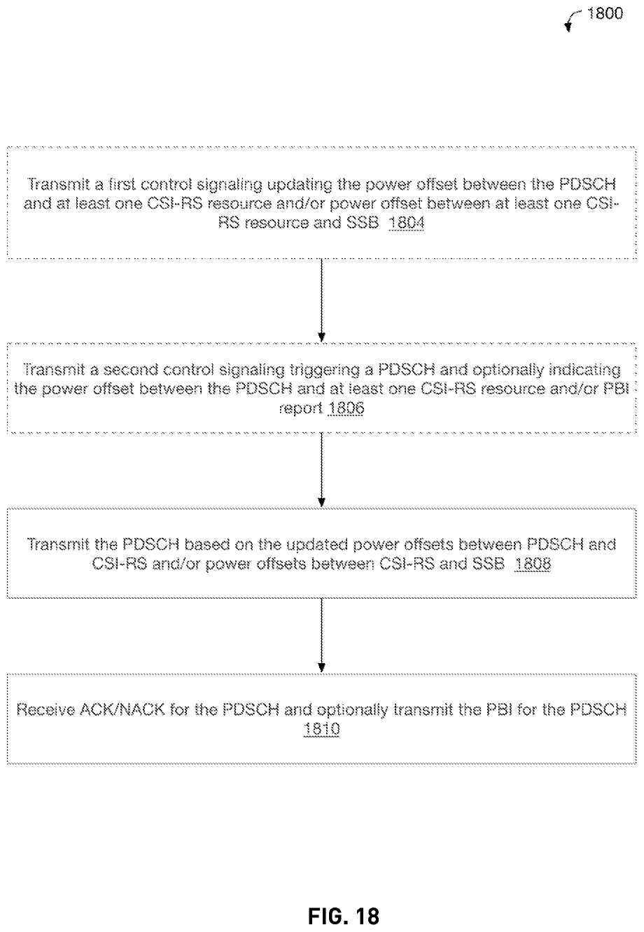

FIG. 18 illustrates an example process 1800 for a network entity that supports dynamic PDSCH transmission power allocation according to some aspects of this disclosure. At block 1804, the network entity transmits a first control signaling updating the power offset between the PDSCH and at least one CSI-RS resource and/or power offset between at least one CSI-RS resource and SSB. At block 1806, the network entity transmits a second control signaling triggering a PDSCH and optionally indicating the power offset between the PDSCH and at least one CSI-RS resource and/or PBI report. At block 1808, the network entity transmits the PDSCH based on the updated power offsets between PDSCH and CSI-RS and/or power offsets between CSI-RS and SSB. At block 1810, the network entity receives the ACK/NACK for the PDSCH and optionally receives the PBI for the PDSCH.

### Power Offset Update

### Option 2-1: Power Offset Update by the Scheduling DCI

In some implementations, the network entity configures the power offset between PDSCH and CSI-RS by the scheduling DCI for the PDSCH.

In some implementations, the network entity configures the updated power offset between the PDSCH and the CSI-RS configured in the indicated TCI state for the PDSCH by the DCI, such as DCI format 1_0, DCI format 1_1 or DCI format 1_2. In some implementations, the indicated updated power offset is applied to the scheduled PDSCH only. In some other implementations, the indicated updated power offset is applied to the scheduled PDSCH and other PDSCHs after the scheduled PDSCH.

In some other implementations, the network entity indicates a power backoff for the PDSCH by the DCI, such as DCI format 1_0, DCI format 1_1 or DCI format 1_2. The power offset between the PDSCH and CSI-RS can be determined based on the configured power backoff for PDSCH and the configured power offset between PDSCH and CSI-RS. In some implementations, the indicated updated power backoff is applied to the scheduled PDSCH only. In some other implementations, the indicated updated power backoff is applied to the scheduled PDSCH and other PDSCHs after the scheduled PDSCH.

In some implementations, the UE reports a UE capability indicating the threshold, i.e., the minimum delay, to apply the indicated updated power offset or power backoff. If the scheduling offset is smaller than the minimum delay, the UE applies a default power offset or power backoff; otherwise, the UE applies the indicated updated power offset or power backoff. In some implementations, the default power offset or power backoff is predefined, such as 0 dB. In some other implementations, the default power offset or power backoff is configured by RRC signaling or MAC CE by the network entity. In some other implementations, the default power offset or power backoff is the power offset or power backoff applied for the most recent PDSCH. In some other implementations, the threshold may be predefined.

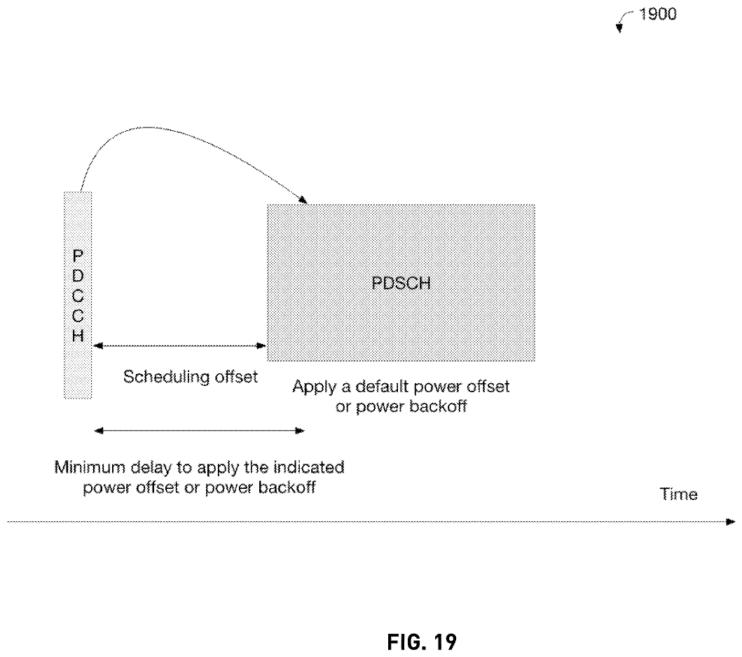

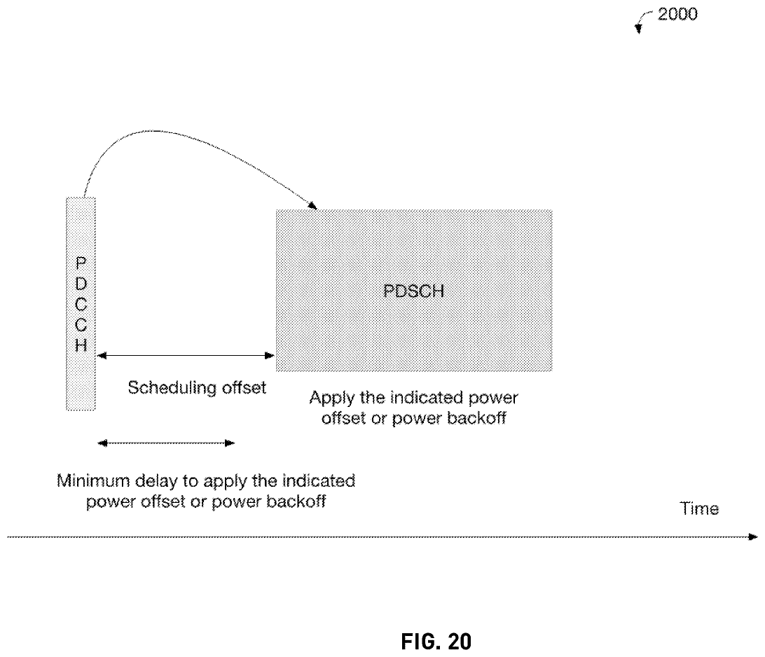

FIG. 19 illustrates an example 1900 for the power offset or power backoff indication when scheduling offset is below the threshold. FIG. 20 illustrates an example 2000 for the power offset or power backoff indication when scheduling offset is above the threshold.

### Option 2-2: Power Offset Update by MAC CE

In some implementations, the network entity configures the power offset between PDSCH and CSI-RS, and/or power offset between the CSI-RS and SSB, and/or the transmission power of one or a subset of or all SSBs in a serving cell by MAC CE.

In some implementations, the network entity configures the updated absolute power offset and/or transmission power by MAC CE. In some implementations, the UE applies the updated power offset and/or transmission power after X millisecond (ms) or slots after it transmits the last symbol of the ACK for the PDSCH with the MAC CE, where X may be predefined, such as X=3, or reported by the UE via UE capability report, or configured by the RRC signaling or MAC CE from the network entity.

In some other implementations, the network entity configures an offset for the power offset and/or transmission power by MAC CE. Then the UE determines the power offset and/or transmission power based on the configured power offset and/or transmission power by RRC signaling and the offset indicated in the MAC CE. In some implementations, the UE applies the updated power offset and/or transmission power after X ms or slots after it transmits the last symbol of the ACK for the PDSCH with the MAC CE, where X is predefined, such as X=3, or reported by the UE via UE capability report, or configured by the RRC signaling or MAC CE from the network entity.

In some implementations, the network entity configures at least one of the elements in the MAC CE additionally: physical cell identifier (PCI), SSB index(es), serving cell index, CSI-RS resource set index(es), and CSI-RS resource index(es). In some other implementations, the UE determines the PCI to apply the MAC CE based on the associated PCI for the PDSCH with the MAC CE, such as the PCI for the QCL source reference signal for the PDSCH.

### Option 2-3: Power Offset Update by DCI

In some implementations, the network entity configures the power offset between PDSCH and CSI-RS, and/or power offset between the CSI-RS and SSB, and/or the transmission power of one or a subset of or all SSBs in a serving cell by DCI. Compared to option 2, the difference is that in option 3, the network entity transmits the indications by a UE-dedicated DCI, such as DCI associated with cell radio network temporary identifier (C-RNTI), or a group-cast DCI, such as DCI associated with a configured RNTI, such as power offset RNTI (PO-RNTI), where the RNTI is configured by RRC signaling from the network entity.

In some implementations, the UE applies the updated power offset and/or transmission power after X ms or slots after it receives the last symbol of the DCI, where X is predefined, such as X=3, or reported by the UE via UE capability report, or configured by the RRC signaling, MAC CE or DCI from the network entity.

### PDSCH Based PBI Report

In some implementations, the network entity configures the UE to report PBI based on PDSCH. In some implementations, the network entity configures the UE to report PBI based on PDSCH by RRC signaling or MAC CE. In some other implementations, the network entity indicates the UE to report PBI based on PDSCH by the scheduling DCI. In one example, in the scheduling DCI, such as DCI format 1_1 or 1_2, the network entity configures a PBI report request to indicate whether the UE shall report PBI for the PDSCH. The PBI report request may take 1 bit, where the first state indicates the UE shall not report PBI and the second state indicates the UE shall report PBI.

The UE measures the PBI based on the offset between the measured SINR and the working SINR based on the indicated MCS for the PDSCH. The UE may report a single wideband PBI across codewords, or a single PBI per codeword, or subband PBIs per codeword or across codewords based on the implementations from option 1-1a to option 1-1e

Option 3-1: PBI Report Associated with ACK/NACK

In some implementations, the UE reports the PBI and ACK/NACK by the PUCCH or PUSCH resource(s) configured by the network entity. The UE may multiplex the bits for ACK/NACK and PBI, and then transmit the multiplexed bits by the configured PUCCH resource(s). In some implementations, the UE multiplexes the ACK/NACK bits for each PDSCH slots first and then the PBI bits for each PDSCH slots. In some other implementations, the UE multiplexes the PBI bits for each PDSCH slots first and then the ACK/NACK bits for each PDSCH slots. In some other implementations, the UE multiplexes the ACK/NACK and PBI for the first PDSCH slot and then the next PDSCH slot(s) corresponding to the ACK/NACK feedback.

Option 3-2: PBI Report Associated with ACK/NACK

In some implementations, the UE reports the PBI and ACK/NACK by different PUCCH or PUSCH resource(s) configured by the network entity. In some implementations, the network entity configures or indicates separate PUCCH resources for PBI and ACK/NACK feedback by RRC or DCI. In some other implementations, the network entity configures PUCCH resource(s) for ACK/NACK feedback and PUSCH for PBI feedback. In some other implementations, the network entity configures PUCCH resource(s) for PBI feedback and PUSCH for ACK/NACK feedback.

FIGS. 1-20 and the operations described herein are examples meant to aid in understanding example implementations and should not be used to limit the potential implementations or limit the scope of the claims. Some implementations may include additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method of wireless communication at a User Equipment (UE), including: receiving, via control signaling from a network entity, a channel state information (CSI) report configuration that indicates at least one CSI reference signal (CSI-RS) resource and includes a power backoff indicator (PBI) report configuration; receiving the at least one CSI-RS resource; and transmitting a PBI report in a CSI report to the network entity, the PBI report including one or more power backoff indicators (PBIs) based on the PBI report configuration and a measurement of the at least one CSI-RS resource.

Clause 2. The method of clause 1, further including: transmitting a UE capability message from the UE to the network entity, where the UE capability message indicates one or more of the following elements: an indication that the UE supports generation of the PBI report, a maximum number of configured CSI-RS resources that the UE can support for the PBI report, or a maximum number of CSI-RS resources in a slot that the UE can support for the PBI report.

Clause 3. The method of any one of clauses 1 to 2, where the PBI report includes: a wideband PBI across all codewords for the CSI report, or a wideband PBI per codeword for the CSI report.

Clause 4. The method of any one of clauses 1-3, further including: determining a wideband channel quality indicator (CQI) based on the measurements of the at least one CSI-RS resource; and determining the one or more PBIs based on the wideband CQI.

Clause 5. The method of any one of clauses 1-4, further including: determining at least one subband channel quality indicator (CQI) based on the measurements of the at least one CSI-RS resource and a configuration of the at least one subband CQI in the CSI report configuration; and determining a transmission power backoff based on the at least one subband CQI, where the one or more PBIs indicate the transmission power backoff.

Clause 6. The method of any one of clauses 1-5, further including: obtaining a subband configuration from the PBI report configuration; and including one or more subband PBIs in the PBI report based on the subband configuration, where the one or more subband PBIs indicate a subband PBI across all codewords of a subband of the at least one CSI-RS or per codeword of the subband.

Clause 7. The method of any one of clauses 1-7, where the transmitting the PBI report includes at least one of: transmitting the one or more PBIs in a short physical uplink control channel (PUCCH) transmission, transmitting the one or more PBIs in CSI part 1 in a long PUCCH transmission or a physical uplink shared channel (PUSCH) transmission, transmitting the one or more PBIs in CSI part 2 in the long PUCCH or the PUSCH, or transmitting a first subset of the one or more PBIs in the CSI part 1 and a second subset of the one or more PBIs in the CSI part 2.

Clause 8. The method of any one of clauses 1-7, where the CSI report configuration includes a CQI subset restriction, the method further including: determining a CQI based on the measurement of the at least one CSI-RS, the CQI selected from among a CQI subset that excludes CQIs indicated in the CQI subset restriction; and determining the one or more PBIs based on a difference between a measured signal-to-noise ratio (SINR) and a working SINR plus offset associated with the CQI.

Clause 9. The method of any one of clauses 1-8, further including: populating a field of the CSI report to include a reported channel quality indicator (CQI) based on the measurements of the at least one CSI-RS resource; including the PBI report in the CSI report when the reported CQI is a highest candidate CQI in a list of possible CQIs; and omitting the PBI report from the CSI report or populating the PBI report with a default value when the reported CQI is other than the highest candidate CQI.

Clause 10. The method of any one of clauses 1-9, further including: receiving, via the control signaling, information indicating at least one target spectrum efficiency; and determining the one or more PBIs based on the at least one target spectrum efficiency.

Clause 11. The method of any one of clauses 1-10, further including: receiving, via the control signaling, a list of candidate power offsets between the at least one CSI-RS and a physical downlink shared channel (PDSCH) for at least one CSI-RS resource; and selecting the one or more PBIs for the PBI report to indicate one or more selected power offset from the list of candidate power offsets.

Clause 12. The method of clause 1, further including: generating the CSI report to include a plurality of CQI corresponding to a plurality of candidate power offsets in the list of candidate power offsets.

Clause 13. The method of clause 12, where the CSI report includes: a common rank indicator (RI) for the plurality of candidate power offsets or respective RIs corresponding to the plurality of candidate power offsets; and a common precoder matrix indicator (PMI) for the plurality of candidate power offsets or respective PMIs corresponding to the plurality of candidate power offsets.

Clause 14. The method of any one of clauses 1-13, where the control signaling indicates a list of CSI-RS resources with different power offsets between the CSI-RS and the physical downlink shared channel (PDSCH), the method further including: transmitting a CSI-RS report with CSI-RS resource indicator (CRI) indicating a recommended CSI-RS; or transmitting the CSI report including more than one CQI corresponding to all the CSI-RS resources with different power offsets.

Clause 15. The method of clause 1, where the control signaling further indicates that the at least one CSI-RS resources are from same antenna ports or that the at least one the CSI-RS resources are from the bandwidth or frequency domain density.

Clause 16. The method of any one of clauses 1-15, where the control signaling indicates a list of CSI-RS resources with different power offsets between the CSI-RS and the physical downlink shared channel (PDSCH), further including: determining how many CSI processing units are needed for the CSI report based on the list of CSI-RS resources; and transmitting information to the network entity indicating an expected processing delay for the CSI report beyond the processing delay for the CSI report to report CSI for CSI-RS resource at one power offset.

Clause 17. The method of any one of clauses 1-16, further including: receiving a media access control (MAC) control element (CE) or downlink control information (DCI) indicating at least one of the elements: a transmission power offset between the at least one CSI-RS resource and PDSCH; a transmission power offset between the at least one CSI-RS resource and synchronization signal block (SSB); a transmission power of at least one SSB; an additional power backoff for the PDSCH; an additional power backoff for the at least one CSI-RS resource; or an additional power backoff for the at least one SSB.

Clause 18. The method of clause 17, further including: receiving the DCI based on a cell radio network temporary identifier (C-RNTI) or a dedicated RNTI.

Clause 19. The method of any one of clauses 1-18, further including: receiving control signaling from the network entity requesting a PBI report based on a PDSCH; and transmitting at least one PBI report based on the PDSCH.

Clause 20. The method of clause 19, further including: transmitting the PBI report and an acknowledgement/non-acknowledgment (ACK/NACK) for the PDSCH, where the PBI report and ACK/NACK are transmitted on same PUCCH resource(s) or PUSCH or where the PBI report is transmitted on one PUCCH resource or PUSCH and the ACK/NACK is transmitted on a different PUCCH resource or PUSCH.

Clause 21. A method of wireless communication at a network entity, including: transmitting, via control signaling to a user equipment (UE), a channel state information (CSI) report configuration that indicates at least one CSI reference signal (CSI-RS) resource and includes a power backoff indicator (PBI) report configuration; transmitting the at least one CSI-RS resource; and receiving a CSI report from the UE, the CSI report including a PBI report that includes one or more power backoff indicators (PBIs).

Clause 22. The method of clause 21, further including: setting a transmission power of a physical downlink shared channel based on the one or more power PBIs.

Clause 23. The method of clause 21 or 22, further including: transmitting a media access control (MAC) control element (CE) or downlink control information (DCI) that indicates at least one of the elements: a power offset between at least one CSI-RS resource and the PDSCH; a power offset between at least one CSI-RS resource and a synchronization signal block (SSB); a transmission power of the at least one SSB an additional power backoff for the PDSCH; an additional power backoff for the at least one CSI-RS resource; or an additional power backoff for the at least one SSB.

Clause 24. An apparatus, including: a communication unit; and a processing system configured to control the communication unit to implement any one of the methods of clauses 1-23.

Clause 25. An apparatus, including a processer configured to cause a User Equipment (UE) to: receive a control signaling configuring at least one channel state information (CSI) report configuration configuring at least a power backoff indicator (PBI) report and at least one CSI reference signal (CSI-RS) resource; receive the at least one CSI-RS resource; transmit a CSI report including at least a PBI report based on the configured CSI report and the received at least one CSI-RS resource.

Clause 26. The apparatus according to clause 25, where UE transmits the UE capability indicating at least one of the elements: whether the UE supports PBI report; the maximum number of configured CSI-RS resources for PBI report; the maximum number of CSI-RS resources in a slot for PBI report.

Clause 27. The apparatus according to clause 25, where the UE transmits a wideband PBI across all the codewords for a CSI report.

Clause 28. The apparatus according to clause 25, where the UE transmits a wideband PBI per codeword for a CSI report.

Clause 29. The apparatus according to clause 27 to clause 28, where the UE determines the PBI based on the reported wideband channel quality indicator (CQI).

Clause 30. The apparatus according to clause 27 to clause 28, where the UE determines the PBI based on at least one of the reported subband CQIs.

Clause 31. The apparatus according to clause 25, where the UE transmits subband PBI(s) across all the codewords for a CSI report.

Clause 32. The apparatus according to clause 25, where the UE transmits subband PBI(s) per codeword for a CSI report.

Clause 33. The apparatus according to clause 31 to clause 32, where the UE receives a control signaling indicating the subband configuration for PBI report.

Clause 34. The apparatus according to clause 27 to clause 32, where the UE transmits the PBI(s) in a short PUCCH.

Clause 35. The apparatus according to clause 27 to clause 32, where the UE transmits the PBI(s) in CSI part 1 in long PUCCH or PUSCH.

Clause 36. The apparatus according to clause 27 to clause 32, where the UE transmits the PBI(s) in CSI part 2 in long PUCCH or PUSCH.

Clause 37. The apparatus according to clause 27 to clause 32, where the UE transmits a subset of PBI(s) in CSI part 1 and the other PBI(s) in CSI part 2 in long PUCCH or PUSCH.

Clause 38. The apparatus according to clause 25, where the UE receives a control signaling indicating a CQI subset restriction.

Clause 39. The apparatus according to clause 25, where the UE transmits the PBI when the reported CQI for the PBI calculation is the highest candidate CQI.

Clause 40. The apparatus according to clause 25, where the UE drops the PBI report when the reported CQI for the PBI calculation is other than the highest candidate CQI.

Clause 41. The apparatus according to clause 25, where the UE transmits the PBI based on a default value when the reported CQI for the PBI calculation is other than the highest candidate CQI.

Clause 42. The apparatus according to clause 25, where the UE receives a control signaling indicating at least one target spectrum efficiency.

Clause 43. The apparatus according to clause 41, where the UE transmits the PBI indicating the PDSCH transmission power backoff to meet the target spectrum efficiency.

Clause 44. The apparatus according to clause 25, where the UE receives a control signaling configuring a list of candidate power offsets between the CSI-RS and PDSCH for at least one CSI-RS resource.

Clause 45. The apparatus according to clause 25, where the UE transmits a CSI report with a PBI indicating one of the candidate power offsets from the list of power offsets.

Clause 46. The apparatus according to clause 45, where the UE transmits a CSI report with more than one CQIs corresponding to the candidate power offsets from the list of power offsets.

Clause 47. The apparatus according to clause 46, where the UE transmits the CSI report with a common rank indicator (RI) and precoder matrix indicator (PMI).

Clause 48. The apparatus according to clause 46, where the UE transmits the CSI report with a common PMI indicating full rank precoder(s), and more than one RIs corresponding to the candidate power offsets from the list of power offsets.

Clause 49. The apparatus according to clause 25, where the UE receives a control signaling configuring a list of CSI-RS resources with different power offsets between the CSI-RS and PDSCH.

Clause 50. The apparatus according to clause 49, where the UE receives a control signaling configuring the CSI-RS resources are from the same antenna ports.

Clause 51. The apparatus according to clause 49, where the UE receives a control signaling configuring the CSI-RS resources are from the bandwidth, and/or frequency domain density.

Clause 52. The apparatus according to clause 49, where the UE transmits a CSI-RS report with CSI-RS resource indicator (CRI) indicating the recommended CSI-RS.

Clause 53. The apparatus according to clause 49, where the UE transmits a CSI-RS report more than one CQIs corresponding to all the CSI-RS resources with different power offsets.

Clause 54. The apparatus according to clause 53, where the UE transmits the CSI report with a common RI and PMI.

Clause 55. The apparatus according to clause 53, where the UE transmits the CSI report with a common PMI indicating full rank precoder(s), and more than one RIs corresponding to the candidate power offsets from the list of power offsets.

Clause 56. The apparatus according to clause 44 to clause 55, where the UE determines that the CSI report takes 1 CSI processing unit.

Clause 57. The apparatus according to clause 56, where the UE transmits a UE capability indicating an additional processing delay for the CSI report on top of the minimum processing delay for a CSI report with one power offset.

Clause 58. The apparatus according to clause 44 to clause 55, where the UE determines that the CSI report takes M CSI processing units, where M is the number of candidate power offsets or CSI-RS resources.

Clause 59. The apparatus according to clause 44 to clause 55, where the UE transmits a UE capability indicating the CSI processing units for the CSI report.

Clause 60. The apparatus according to clause 25, where the UE receives a MAC CE or DCI updating at least one of the elements: the power offset between at least one CSI-RS resource and PDSCH; the power offset between at least one CSI-RS resource and SSB; the transmission power of at least one SSB.

Clause 61. The apparatus according to clause 25, where the UE receives a MAC CE or DCI indicating at least one of the elements: the additional power backoff for PDSCH; the additional power backoff for at least one CSI-RS resource; the additional power backoff for at least one SSB.

Clause 62. The apparatus according to clause 60 to clause 61, where the UE receives the DCI based on cell radio network temporary identifier (C-RNTI).

Clause 63. The apparatus according to clause 60 to clause 61, where the UE receives the DCI based on a dedicated RNTI.

Clause 64. The apparatus according to clause 63, where the UE receives a control signaling configuring the dedicated RNTI.

Clause 65. The apparatus according to clause 25, where the UE receives a control signaling indicating a PBI report based on a PDSCH.

Clause 66. The apparatus according to clause 65, where the UE transmits at least one PBI based on a received PDSCH.

Clause 67. The apparatus according to clause 65, where the UE transmits the PBI and ACK/NACK for the PDSCH by the same PUCCH resource(s) or PUSCH.

Clause 68. The apparatus according to clause 65, where the UE transmits the PBI and ACK/NACK for the PDSCH by different PUCCH resource(s) or PUSCH.

Clause 69. The apparatus according to clause 65, where the UE receives a control signaling configuring the PUCCH resource(s) or PUSCH for PBI report and/or ACK/NACK report.

Clause 70. An apparatus, including a processer configured to cause a Base Station (BS) to: transmit a control signaling configuring at least one channel state information (CSI) report configuration configuring at least a power backoff indicator (PBI) report and at least one CSI reference signal (CSI-RS) resource; transmit the at least one CSI-RS resource; receive a CSI report including at least a PBI report based on the configured CSI report and the received at least one CSI-RS resource.

Clause 71. The apparatus according to clause 70, where the BS receives the UE capability indicating at least one of the elements: whether the UE supports PBI report; the maximum number of configured CSI-RS resources for PBI report; the maximum number of CSI-RS resources in a slot for PBI report.

Clause 72. The apparatus according to clause 70, where the BS receives a wideband PBI across all the codewords for a CSI report.

Clause 73. The apparatus according to clause 70, where the BS receives a wideband PBI per codeword for a CSI report.

Clause 74. The apparatus according to clause 70, where the BS receives subband PBI(s) across all the codewords for a CSI report.

Clause 75. The apparatus according to clause 70, where the BS receives subband PBI(s) per codeword for a CSI report.

Clause 76. The apparatus according to clause 74 to clause 75, where the BS transmits a control signaling indicating the subband configuration for PBI report.

Clause 77. The apparatus according to clause 72 to clause 75, where the BS receives the PBI(s) in a short PUCCH.

Clause 78. The apparatus according to clause 72 to clause 75, where the BS receives the PBI(s) in CSI part 1 in long PUCCH or PUSCH.

Clause 79. The apparatus according to clause 72 to clause 75, where the BS receives the PBI(s) in CSI part 2 in long PUCCH or PUSCH.

Clause 80. The apparatus according to clause 72 to clause 75, where the BS receives a subset of PBI(s) in CSI part 1 and the other PBI(s) in CSI part 2 in long PUCCH or PUSCH.

Clause 81. The apparatus according to clause 70, where the BS transmits a control signaling indicating a CQI subset restriction.

Clause 82. The apparatus according to clause 70, where the BS receives the PBI when the reported CQI for the PBI calculation is the highest candidate CQI.

Clause 83. The apparatus according to clause 70, where the BS receives the PBI based on a default value when the reported CQI for the PBI calculation is other than the highest candidate CQI.

Clause 84. The apparatus according to clause 70, where the BS transmits a control signaling indicating at least one target spectrum efficiency.

Clause 85. The apparatus according to clause 84, where the BS receives the PBI indicating the PDSCH transmission power backoff to meet the target spectrum efficiency.

Clause 86. The apparatus according to clause 70, where the BS transmits a control signaling configuring a list of candidate power offsets between the CSI-RS and PDSCH for at least one CSI-RS resource.

Clause 87. The apparatus according to clause 86, where the BS receives a CSI report with a PBI indicating one of the candidate power offsets from the list of power offsets.

Clause 88. The apparatus according to clause 86, where the BS receives a CSI report with more than one CQIs corresponding to the candidate power offsets from the list of power offsets.

Clause 89. The apparatus according to clause 88, where the BS receives the CSI report with a common rank indicator (RI) and precoder matrix indicator (PMI).

Clause 90. The apparatus according to clause 88, where the BS receives the CSI report with a common PMI indicating full rank precoder(s), and more than one RIs corresponding to the candidate power offsets from the list of power offsets.

Clause 91. The apparatus according to clause 70, where the BS transmits a control signaling configuring a list of CSI-RS resources with different power offsets between the CSI-RS and PDSCH.

Clause 92. The apparatus according to clause 91, where the BS transmits a control signaling configuring the CSI-RS resources are from the same antenna ports.

Clause 93. The apparatus according to clause 91, where the BS transmits a control signaling configuring the CSI-RS resources are from the bandwidth, and/or frequency domain density.

Clause 94. The apparatus according to clause 91, where the BS receives a CSI-RS report with CSI-RS resource indicator (CRI) indicating the recommended CSI-RS.

Clause 95. The apparatus according to clause 91, where the BS receives a CSI-RS report more than one CQIs corresponding to all the CSI-RS resources with different power offsets.

Clause 96. The apparatus according to clause 95, where the BS receives the CSI report with a common RI and PMI.

Clause 97. The apparatus according to clause 95, where the BS receives the CSI report with a common PMI indicating full rank precoder(s), and more than one RIs corresponding to the candidate power offsets from the list of power offsets.

Clause 98. The apparatus according to clause 86 to clause 97, where the BS determines that the CSI report takes 1 CSI processing unit.

Clause 99. The apparatus according to clause 98, where the BS receives a UE capability indicating an additional processing delay for the CSI report on top of the minimum processing delay for a CSI report with one power offset.

Clause 100. The apparatus according to clause 86 to clause 97, where the BS determines that the CSI report takes M CSI processing units, where M is the number of candidate power offsets or CSI-RS resources.

Clause 101. The apparatus according to clause 86 to clause 97, where the BS receives a UE capability indicating the CSI processing units for the CSI report.

Clause 102. The apparatus according to clause 70, where the BS transmits a MAC CE or DCI updating at least one of the elements: the power offset between at least one CSI-RS resource and PDSCH; the power offset between at least one CSI-RS resource and SSB; the transmission power of at least one SSB.

Clause 103. The apparatus according to clause 70, where the BS transmits a MAC CE or DCI indicating at least one of the elements: the additional power backoff for PDSCH; the additional power backoff for at least one CSI-RS resource; the additional power backoff for at least one SSB.

Clause 104. The apparatus according to clause 103 to clause 84, where the BS transmits the DCI based on cell radio network temporary identifier (C-RNTI).

Clause 105. The apparatus according to clause 103 to clause 104, where the BS transmits the DCI based on a dedicated RNTI.

Clause 106. The apparatus according to clause 105, where the BS transmits a control signaling configuring the dedicated RNTI.

Clause 107. The apparatus according to clause 70, where the BS transmits a control signaling indicating a PBI report based on a PDSCH.

Clause 108. The apparatus according to clause 107, where the BS receives at least one PBI based on a received PDSCH.

Clause 109. The apparatus according to clause 107, where the BS receives the PBI and ACK/NACK for the PDSCH by the same PUCCH resource(s) or PUSCH.

Clause 110. The apparatus according to clause 107, where the BS receives the PBI and ACK/NACK for the PDSCH by different PUCCH resource(s) or PUSCH.

Clause 111. The apparatus according to clause 107, where the BS transmits a control signaling.

Another innovative aspect of the subject matter described in this disclosure can be implemented as a wireless communication device of a UE or a network entity. The wireless communication device may include at least one interface and a processing system communicatively coupled with the at least one interface. The processing system may be configured to implement any one of the above clauses.

Another innovative aspect of the subject matter described in this disclosure can be implemented as a portable electronic device comprising a wireless communication device, a plurality of antennas coupled to the at least one transceiver to wirelessly transmit signals output from the at least one transceiver and a housing that encompasses the wireless communication device, the at least one transceiver and at least a portion of the plurality of antennas. The wireless communication device may include at least one interface and a processing system communicatively coupled with the at least one interface. The processing system may be configured to implement any one of the above clauses.

Another innovative aspect of the subject matter described in this disclosure can be implemented as a machine-readable medium having processor-readable instructions stored therein that, when executed by a processing system of a UE, cause the UE to implement any one of the above clauses.

Another innovative aspect of the subject matter described in this disclosure can be implemented as an apparatus. The apparatus may include means for implementing any one of the above clauses.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

In this disclosure, the term “can” indicates a capability, or alternatively indicates a possible implementation option. The term “may” indicates a permission or a possible implementation option.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IOT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method of wireless communication at a User Equipment (UE), comprising:
receiving, via control signaling from a network entity, a channel state information (CSI) report configuration that indicates at least one CSI reference signal (CSI-RS) resource and includes a power backoff indicator (PBI) report configuration indicating different power offsets between the at least one CSI-RS resource and a physical downlink shared channel (PDSCH);
receiving the at least one CSI-RS resource;
determining, based on measurement of the at least one CSI-RS resource, a channel quality indicator (CQI) associated with each of the different power offsets; and
transmitting a PBI report in a CSI report to the network entity, the PBI report including one or more power backoff indicators (PBIs) based on the PBI report configuration, the one or more PBIs indicating a corresponding plurality of CQIs associated with the different power offsets.

2. The method of claim 1, further comprising:
transmitting a UE capability message from the UE to the network entity, wherein the UE capability message indicates one or more of the following elements:
an indication that the UE supports generation of the PBI report,
a maximum number of configured CSI-RS resources that the UE can support for the PBI report, or
a maximum number of CSI-RS resources in a slot that the UE can support for the PBI report,
wherein the maximum number of configured CSI-RS resources is one of a maximum number of configured CSI-RS resources per component carrier or a maximum number of configured CSI-RS resources across all component carriers.

3. The method of claim 1, further comprising:
determining a wideband channel quality indicator (CQI) based on the measurements of the at least one CSI-RS resource; and
determining the one or more PBIs based on the wideband CQI, wherein the PBI report includes a wideband PBI across all codewords for the CSI report or a wideband PBI per codeword for the CSI report.

4. (canceled)

5. The method of claim 1, further comprising:
obtaining a subband configuration from the PBI report configuration;
determining at least one subband channel quality indicator (CQI) based on the measurements of the at least one CSI-RS resource and a configuration of the at least one subband CQI in the CSI report configuration;
determining a transmission power backoff based on the at least one subband CQI, wherein the one or more PBIs indicate the transmission power backoff; and
including one or more subband PBIs in the PBI report based on the subband configuration, wherein the one or more subband PBIs indicate a subband PBI across all codewords of a subband of the at least one CSI-RS resource or per codeword of the subband.

6. (canceled)

7. The method of claim 1, wherein the transmitting the PBI report includes at least one of:
transmitting the one or more PBIs in a short physical uplink control channel (PUCCH) transmission,
transmitting the one or more PBIs in CSI part 1 in a long PUCCH transmission or a physical uplink shared channel (PUSCH) transmission,
transmitting the one or more PBIs in CSI part 2 in the long PUCCH transmission or the PUSCH transmission, or
transmitting a first subset of the one or more PBIs in the CSI part 1 and a second subset of the one or more PBIs in the CSI part 2.

8. The method of claim 1, wherein the CSI report configuration includes a CQI subset restriction, the method further comprising:
determining a CQI based on the measurement of the at least one CSI-RS resource, the CQI selected from among a CQI subset that excludes CQIs indicated in the CQI subset restriction; and
determining the one or more PBIs based on a difference between a measured signal-to-noise ratio (SINR) and a working SINR plus offset associated with the CQI.

9. The method of claim 1, further comprising:
populating a field of the CSI report to include a reported channel quality indicator (CQI) based on the measurements of the at least one CSI-RS resource;
including the PBI report in the CSI report when the reported CQI is a highest candidate CQI in a list of possible CQIs; and
omitting the PBI report from the CSI report or populating the PBI report with a default value when the reported CQI is other than the highest candidate CQI.

10. The method of claim 1, further comprising:
receiving, via the control signaling, information indicating at least one target spectrum efficiency; and
determining the one or more PBIs based on the at least one target spectrum efficiency.

11. The method of claim 1, further comprising:
receiving, via the control signaling, a list of candidate power offsets between the at least one CSI-RS resource and a physical downlink shared channel (PDSCH);
selecting the one or more PBIs for the PBI report to indicate one or more selected power offset from the list of candidate power offsets; and
generating the CSI report to include a plurality of CQI corresponding to a plurality of candidate power offsets in the list of candidate power offsets.

12. (canceled)

13. The method of claim 11, wherein the CSI report includes:
a common rank indicator (RI) for the plurality of candidate power offsets or respective RIs corresponding to the plurality of candidate power offsets; and
a common precoder matrix indicator (PMI) for the plurality of candidate power offsets or respective PMIs corresponding to the plurality of candidate power offsets.

14. The method of claim 1, wherein the at least one CSI-RS resource includes a list of CSI-RS resources with the different power offsets, and wherein the one or more PBIs are reported as one or more CSI-RS resource indicators (CRIs) corresponding to the plurality of CQIs associated with the different power offsets.

15. The method of claim 1, wherein the control signaling further indicates that CSI-RS resources are from same antenna ports or that the CSI-RS resources are from same bandwidth or frequency domain density.

16. The method of claim 1, wherein the control signaling indicates a list of CSI-RS resources with the different power offsets between the at least one CSI-RS resource and the PDSCH, further comprising:
determining how many CSI processing units are needed for the CSI report based on the list of CSI-RS resources; and
transmitting information to the network entity indicating an expected processing delay for the CSI report beyond the processing delay for the CSI report to report CSI for a CSI-RS resource at one power offset.

17. The method of claim 1, further comprising:
receiving second control signaling indicating at least one of:
a transmission power offset between the at least one CSI-RS resource and the PDSCH;
a transmission power offset between the at least one CSI-RS resource and synchronization signal block (SSB);
a transmission power of at least one SSB;
an additional power backoff for the PDSCH;
an additional power backoff for the at least one CSI-RS resource; or
an additional power backoff for the at least one SSB.

18. The method of claim 1, further comprising:
receiving control signaling from the network entity requesting a PBI report based on the PDSCH; and
transmitting at least one PBI report and an acknowledgement/non-acknowledgment (ACK/NACK) for the PDSCH, wherein the PBI report and ACK/NACK are transmitted on same PUCCH resource or PUSCH resource or wherein the PBI report is transmitted on one PUCCH resource or PUSCH resource and the ACK/NACK is transmitted on a different PUCCH resource or PUSCH resource.

19. (canceled)

20. A method of wireless communication at a network entity, comprising:
receiving, from a user equipment (UE), a UE capability message;
transmitting, via control signaling to the UE, a channel state information (CSI) report configuration that indicates at least one CSI reference signal (CSI-RS) resource and includes a power backoff indicator (PBI) report configuration, indicating different power offsets between the at least one CSI-RS resource and a physical downlink shared channel (PDSCH);
transmitting the at least one CSI-RS resource; and
receiving a CSI report from the UE, the CSI report including a PBI report that includes one or more power backoff indicators (PBIs), the one or more PBIs indicating a corresponding plurality of CQIs associated with the different power offsets,
wherein the UE capability message indicates one or more of the following elements:
an indication that the UE supports generation of the PBI report,
a maximum number of configured CSI-RS resources that the UE can support for the PBI report, or
a maximum number of CSI-RS resources in a slot that the UE can support for the PBI report,
wherein the maximum number of configured CSI-RS resources is one of: a maximum number of configured CSI-RS resources per component carrier or a maximum number of configured CSI-RS resources across all component carriers.

21. The method of claim 20, further comprising:
setting a transmission power of a PDSCH transmission based on the one or more power PBIs, wherein the at least one CSI-RS resource includes a list of CSI-RS resources with the different power offsets, and wherein the one or more PBIs are reported as one or more CSI-RS resource indicators (CRIs) corresponding to the plurality of CQIs associated with the different power offsets.

22. The method of claim 20, further comprising:
transmitting a second control signaling that indicates at least one of the elements:
a power offset between at least one CSI-RS resource and the PDSCH;
a power offset between at least one CSI-RS resource and a synchronization signal block (SSB);
a transmission power of at least one SSB
an additional power backoff for the PDSCH;
an additional power backoff for the at least one CSI-RS resource; or
an additional power backoff for the at least one SSB.

23-24. (canceled)

25. A User Equipment (UE), comprising:
a communication unit; and
a processing system configured to control the communication unit to:
receive, via control signaling from a network entity, a channel state information (CSI) report configuration that indicates at least one CSI reference signal (CSI-RS) resource and includes a power backoff indicator (PBI) report configuration indicating different power offsets between the at least one CSI-RS resource and a physical downlink shared channel (PDSCH),
receive the at least one CSI-RS resource,
determine, based on measurement of the at least one CSI-RS resource, a channel quality indicator (CQI) associated with each of the different power offsets, and
transmit a PBI report in a CSI report to the network entity, the PBI report including one or more power backoff indicators (PBIs) based on the PBI report configuration, the one or more PBIs indicating a corresponding plurality of CQIs associated with the different power offsets.

26. The UE of claim 25, wherein the processing system is further configured to control the communication unit to:
transmit a UE capability message from the UE to the network entity, wherein the UE capability message indicates one or more of the following elements:
an indication that the UE supports generation of the PBI report,
a maximum number of configured CSI-RS resources that the UE can support for the PBI report, or
a maximum number of CSI-RS resources in a slot that the UE can support for the PBI report,
wherein the maximum number of configured CSI-RS resources is one of a maximum number of configured CSI-RS resources per component carrier or a maximum number of configured CSI-RS resources across all component carriers.
